(19) United States
(12) Patent Application Publication
(10) Pub. No.: US 2021/0149416 A1
(43) Pub. Date: May 20, 2021

(54) METHOD AND SYSTEM FOR FACILITATING OPERATIONS IN STORAGE FACILITIES

(71) Applicant: GREY ORANGE PTE. LTD., Singapore (SG)

(72) Inventor: Varun SRIVASTAVA, New Delhi (IN)

(73) Assignee: GREY ORANGE PTE. LTD., Singapore (SG)

(21) Appl. No.: 16/688,757

(22) Filed: Nov. 19, 2019

(51) Int. Cl. G05D 1/02; G05D 1/00; B60L 53/60

(52) U.S. Cl. CPC G05D 1/0287; B60L 53/60; G05D 1/0088

(57) ABSTRACT

A method for facilitating one or more operations in a storage facility is provided. A server is in communication with a primary automated guided vehicle (AGV) that is configured to execute a first operation in the storage facility and one or more auxiliary AGVs. Each auxiliary AGV is configured to execute an auxiliary operation. When the primary AGV requires a first type of service, the server selects a first auxiliary AGV from the one or more auxiliary AGVs to provide the first type of service to the primary AGV. The server, then, communicates a first set of instructions to the first auxiliary AGV. Based on the first set of instructions, the first auxiliary AGV executes a corresponding auxiliary operation to provide the first type of service to the primary AGV.

### FIELD OF THE INVENTION

The present disclosure relates generally to management of storage facilities, and, more particularly to a method and a system for facilitating one or more operations in a storage facility.

### BACKGROUND

Typically, in a storage facility, inventory items are stored in shelves of storage units. Examples of the inventory items include, but are not limited to, groceries, apparel, or the like. Several such storage facilities (such as warehouses or retail stores) utilize automated guided vehicles (“AGV”) to transport the inventory items or the storage units between various locations in the storage facilities. For example, in one scenario, an AGV in a first storage facility may carry a first storage unit from a first location to a second location in the first storage facility.

There may occur scenarios that necessitate removal of one or more AGVs from service in the first storage facility. Such scenarios may arise a result of faults (e.g., failures in circuitries) in the one or more AGVs, operational costs (e.g., battery consumption) associated with the one or more AGVs, or the like. For example, a failure in a navigation circuit in an AGV may warrant a replacement or a repair of the navigation circuit, requiring the AGV to be taken out of service until the navigation circuit is rectified. In another example, a complete discharge of a battery in an AGV may warrant a charging of the battery or a replacement of the discharged battery, requiring the AGV to be taken out of service until the battery is charged or replaced. Such downtimes of the AGV may have significant ramifications on operations at the storage facility, often reducing a throughput of the storage facility. One solution to avoid downtime of the AGVs involves maintaining redundant AGVs and allowing the redundant AGVs to substitute AGVs that are taken out of service. Another solution involves including redundant hardware components within the AGVs. Such solutions may help in maintaining a throughput of the storage facility in case of contingencies. However, these solutions may prove to be prohibitively expensive as introduction of redundant AGVs or redundant hardware components in the AGVs may involve high capital investment. In other words, the above solutions may not be economically feasible.

In light of the foregoing, there exists a need for a technical solution that prevents operations at a storage facility from being adversely affected due to failure of one or more AGVs.

### SUMMARY

In an embodiment of the present disclosure, a system for facilitating one or more operations in a storage facility is provided. The system includes a server, a primary automated guided vehicle (AGV), and one or more auxiliary AGVs. The primary AGV is configured to execute a first operation of the one or more operations. Each auxiliary AGV is configured to execute an auxiliary operation. The server is in communication with the primary AGV and the one or more auxiliary AGVs. The server is configured to determine a requirement of the primary AGV for a first type of service. The server selects a first auxiliary AGV from the one or more auxiliary AGVs based on the determination of the requirement for the first type of service. The server communicates a first set of instructions to the first auxiliary AGV. Based on the first set of instructions, the first auxiliary AGV executes a corresponding auxiliary operation to provide the first type of service to the primary AGV.

In another embodiment of the present disclosure, a method for facilitating one or more operations in a storage facility is provided. The method includes determining, by a server, a requirement of a primary AGV for a first type of service. The primary AGV is configured to execute a first operation of the one or more operations. A first auxiliary AGV from one or more auxiliary AGVs is selected by the server based on the determination of the requirement for the first type of service. Each auxiliary AGV is configured to execute an auxiliary operation. A first set of instructions is communicated by the server to the first auxiliary AGV. Based on the first set of instructions, the first auxiliary AGV executes a corresponding auxiliary operation to provide the first type of service to the primary AGV.

In another embodiment of the present disclosure, a primary AGV is provided. The primary AGV comprises a movement mechanism for traversing a path in a storage facility to execute a first operation. The primary AGV further comprises an engagement mechanism for allowing one or more auxiliary AGVs to engage with the primary AGV. When the primary AGV requires a first type of service, an auxiliary AGV of the one or more auxiliary AGVs engages with the primary AGV by way of the engagement mechanism and provides the first type of service to the primary AGV.

### BRIEF DESCRIPTION OF THE DRAWINGS

The accompanying drawings illustrate the various embodiments of systems, methods, and other aspects of the disclosure. It will be apparent to a person skilled in the art that the illustrated element boundaries (e.g., boxes, groups of boxes, or other shapes) in the figures represent one example of the boundaries. In some embodiments, one element may be designed as multiple elements, or multiple elements may be designed as one element. In some embodiments, an element shown as an internal component of one element may be implemented as an external component in another, and vice versa.

Various embodiments of the present disclosure are illustrated by way of example, and not limited by the appended figures, in which like references indicate similar elements:

FIG. 1 is a block diagram that illustrates an embodiment of an exemplary environment, in accordance with one embodiment of the present disclosure;

FIG. 2A is a block diagram that illustrates a primary automated guided vehicle (AGV) of FIG. 1, in accordance with one embodiment of the present disclosure;

FIG. 2B is a block diagram that illustrates the primary AGV carrying a storage unit of a rack of FIG. 1, in accordance with one embodiment of the present disclosure;

FIGS. 3A-3E are block diagrams that collectively illustrate an exemplary scenario for providing a battery charging service to the primary AGV, in accordance with one non-limiting embodiment of the present disclosure;

FIGS. 4A and 4B are block diagrams that collectively illustrate an exemplary scenario for providing a navigation service to the primary AGV, in accordance with one embodiment of the present disclosure;

FIG. 5 is a block diagram that illustrates an exemplary scenario for providing a lifting service to the primary AGV, in accordance with one embodiment of the present disclosure;

FIGS. 6A-6C are block diagrams that collectively illustrate an exemplary scenario for providing a path clearance service for the primary AGV, in accordance with one embodiment of the present disclosure;

FIG. 7 is a block diagram that illustrates a control server of FIG. 1, in accordance with one embodiment of the present disclosure;

FIG. 8 is a block diagram that illustrates system architecture of a computer system, in accordance with one embodiment of the present disclosure;

FIGS. 9A and 9B, collectively represent a flow chart that illustrates the method for facilitating one or more operations in the storage facility, in accordance with one embodiment of the present disclosure; and

FIGS. 10A and 10B, collectively represent a flow chart that illustrates the method for facilitating one or more operations in the storage facility, in accordance with another embodiment of the present disclosure.

Further areas of applicability of the present disclosure will become apparent from the detailed description provided hereinafter. It should be understood that the detailed description of exemplary embodiments is intended for illustration purposes only and is, therefore, not intended to necessarily limit the scope of the disclosure.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. In one example, the teachings presented and the needs of a particular application may yield multiple alternate and suitable approaches to implement the functionality of any detail described herein. Therefore, any approach may extend beyond the particular implementation choices in the following embodiments that are described and shown.

References to “an embodiment”, “another embodiment”, “yet another embodiment”, “one example”, “another example”, “yet another example”, “for example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

Various embodiments of the present disclosure provide a method and a system for facilitating one or more operations in a storage facility. The system includes at least one primary automated guided vehicle (AGV), one or more auxiliary AGVs, and a server. The server is in communication with the primary AGV and the one or more auxiliary AGVs. The primary AGV is executing a first operation (e.g., transporting a storage unit from one location to another location in the storage facility) of the one or more operations. The server may determine a first type of service required by the primary AGV. Examples of the first type of service may include a battery charging service, a lifting service, a navigation service, a path clearance service, or an assistance service for an operation in an assembly line of a manufacturing plant. For example, the server may determine that the primary AGV requires a battery charging service based on a battery level of a battery of the primary AGV. In another example, the server may determine that the primary AGV requires a navigation service based on a failure of a navigation unit of the primary AGV. Each auxiliary AGV may be capable of executing a corresponding auxiliary operation (e.g., a battery charging operation, a lifting operation, a navigation operation, a path clearance operation, or an assisting operation) to provide the corresponding type of service. Based on the determination of the first type of service required by the primary AGV, the server may select a first auxiliary AGV from the one or more auxiliary AGVs that is capable of providing the first type of service. Based on the selection, the server may communicate a set of instructions to the first auxiliary AGV, instructing the first auxiliary AGV to execute a corresponding auxiliary operation to provide the first type of service required by the primary AGV. Based on the set of instructions, the first auxiliary AGV executes the corresponding auxiliary operation to provide the first type of service required by the primary AGV. For example, the first auxiliary AGV may execute a battery charging operation to charge the battery of the primary AGV. The first auxiliary AGV executes the corresponding auxiliary operation while the primary AGV continues to execute the first operation without any hindrance. Thus, the execution of the first operation by the primary AGV is not interrupted due the requirement of the first type of service by the primary AGV.

According to some embodiments, a “Storage facility” may be a warehouse or a retail store that includes one or more storage units for storing inventory items. In another example, the storage facility may be a storage area for a manufacturing plant. The storage facility may further include one or more aisles for primary and auxiliary automated guided vehicles (AGVs) to move in the storage facility. Examples of the storage facility may include, but are not limited to, a forward warehouse, a backward warehouse, or a retail store.

According to some embodiments, a “Primary AGV” is a robotic vehicle that executes one or more operations in a storage facility, such as transporting items or storage units from one location to another in the storage facility. For example, a first primary AGV may transport a storage unit from a first location to a second location in the storage facility for item retrieval or item placement in the storage unit.

According to some embodiments, a “First type of service” refers to a service that may be required by a primary AGV for successful completion of an operation being executed by the primary AGV. Examples of the first type of service may include, but are not limited to, a battery charging service, a navigation service, a lifting service, or a path clearance service.

According to some embodiments, an “Auxiliary AGV” is a robotic vehicle that is capable of performing an auxiliary operation to provide a specific type of service required by a primary AGV. For example, a first auxiliary AGV may execute a battery charging operation to provide a battery charging service to the primary AGV. In another example, a second auxiliary AGV may execute a navigation operation to provide a navigation service to the primary AGV. In another example, a third auxiliary AGV may execute a lifting operation to provide a lifting service to the primary AGV. In another example, a fourth auxiliary AGV may execute a path clearance operation to provide a path clearance service to the primary AGV.

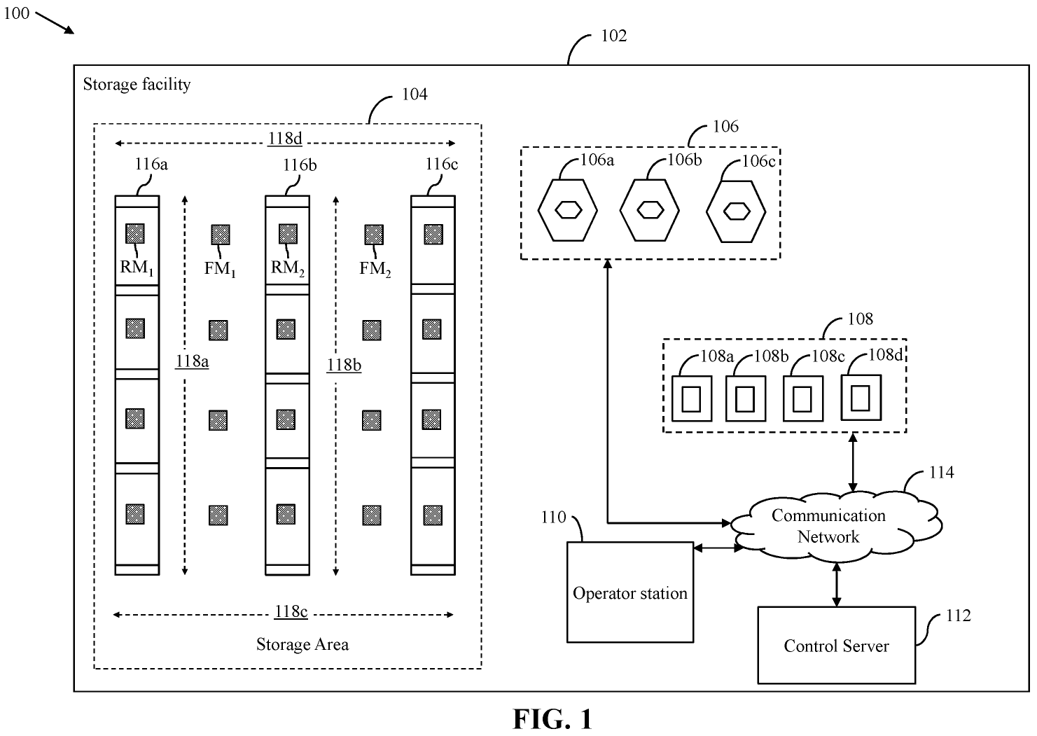

FIG. 1 is a block diagram that illustrates an embodiment of an exemplary environment 100, in accordance with one embodiment of the present disclosure. The environment 100 shows a storage facility 102. The storage facility 102 includes a storage area 104, first through third primary automated guided vehicles (AGVs) 106a-106c (hereinafter, the first through third primary AGVs 106a-106c are referred to as ‘the primary AGVs 106’), first through fourth auxiliary AGVs 108a-108d (hereinafter, the first through fourth auxiliary AGVs 108a-108d are referred to as ‘the auxiliary AGVs 108’), an operator station 110, and a control server (CS) 112. The CS 112 communicates with the primary AGVs 106, the auxiliary AGVs 108, and the operator station 110 by way of a communication network 114 or through separate communication networks established therebetween.

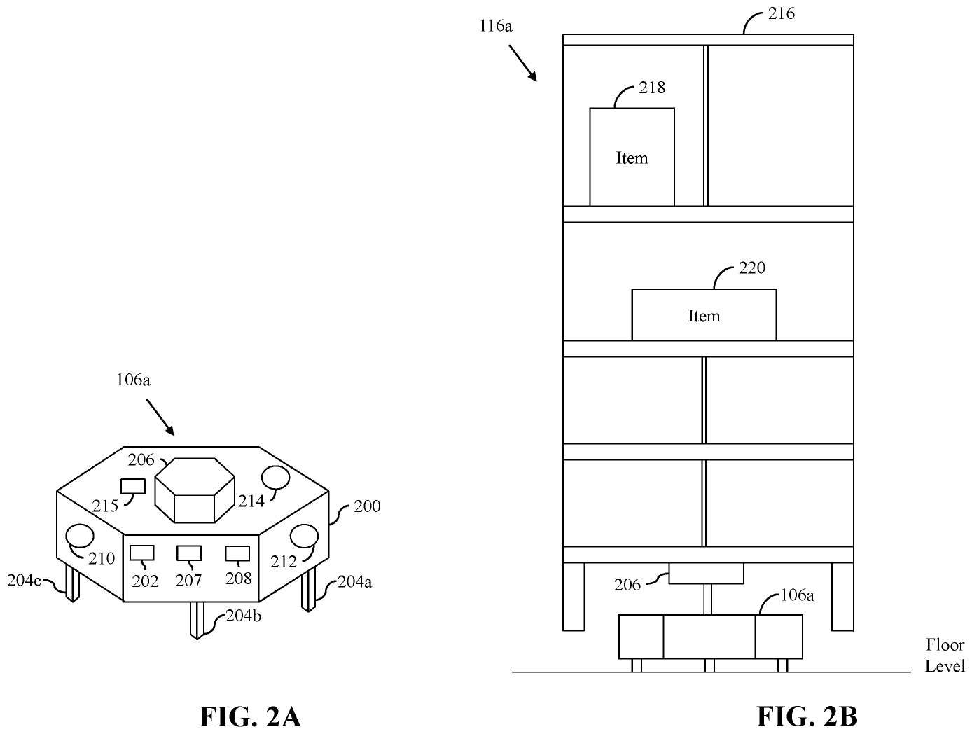

The storage facility 102 stores multiple inventory items for fulfillment and/or selling. Examples of the storage facility 102 may include, but are not limited to, a forward warehouse, a backward warehouse, a fulfilment center, a storage area in a manufacturing plant, or a retail store (e.g., a supermarket, an apparel store, or the like). Examples of the inventory items may include, but are not limited to, groceries, apparel, or the like. The inventory items are stored in the storage area 104. The storage area 104 may be of any shape, for example, a rectangular shape. The storage area 104 includes first through third racks 116a-116c for storing the inventory items. Hereinafter, the first through third racks 116a-116c are collectively referred to as ‘the racks 116’. Each rack 116 includes various storage units 216 (as shown in FIG. 2B). In other words, each rack 116 is formed by linearly arranging the storage units 216. One or more inventory items are allocated to each storage unit and each storage unit stores the corresponding allocated inventory items. In one embodiment, the storage units may have different shapes, sizes, and dimensions. Hereinafter, the terms ‘inventory items’ and “items” are used interchangeably.

The racks 116 are arranged such that first through fourth aisles 118a-118d (hereinafter, the first through fourth aisles 118a-118d are collectively referred to as ‘the aisles 118’) are formed therebetween. The first aisle 118a is formed between the first and second racks 116a and 116b. The second aisle 118b is formed between the second and third racks 116b and 116c. The third and fourth aisles 118c and 118d are formed between side faces of the racks 116 and sidewalls of the storage area 104. The aisles 118 are passageways used by customers, the primary AGVs 106, and/or the auxiliary AGVs 108 to move through the storage area 104. Arrangement of the racks 116 is a standard practice and will be apparent to those of skill in the art. In one embodiment, the racks 116 are arranged such that a layout of the aisles 118 forms a virtual grid in a rectangular space. Thus, each aisle 118 is one of a horizontal aisle or a vertical aisle. For example, the first aisle 118a may be a vertical aisle and the fourth aisle 118d may be a horizontal aisle. An intersection between horizontal and vertical aisles forms a cross-aisle.

The storage facility 102 may be marked with various fiducial markers (such as FM₁, FM₂, RM₁, and RM₂). For the sake of illustration, in FIG. 1 the storage area 104 has been shown to include multiple fiducial markers and only the fiducial markers FM₁, FM₂, RM₁, and RM₂ have been labelled. It will be apparent to those of skill in the art that the entire storage facility 102 may include the fiducial markers without deviating from the scope of the present disclosure. Each fiducial marker may correspond to one of two types—location markers (such as the location markers FM₁ and FM₂) and rack markers (such as the rack markers RM₁ and RM₂). The location markers are located at pre-determined locations in the storage facility 102. The pre-determined locations may or may not conform to a specific pattern and may be subject to a configuration of the storage facility 102. For example, the fiducial markers FM₁ and FM₂ may be located at first and second locations (for example, on the floor of the storage area 104) along the first and second aisles 118a and 118b, respectively. The rack markers may uniquely identify each storage unit 216 that constitute the racks 116. For example, the rack markers RM₁ and RM₂ may uniquely identify storage units that partly constitute the first and second racks 116a and 116b, respectively. Examples of the fiducial markers include, but or not limited to, barcodes, quick response (QR) codes, radio frequency identification device (RFID) tags, or the like. In one embodiment, a placement of the fiducial markers may be uniform (i.e., a distance between consecutive fiducial markers is constant). In another embodiment, the placement of the fiducial markers may be non-uniform (i.e., a distance between consecutive fiducial markers is variable).

The primary AGVs 106 are robotic vehicles that move in the storage facility 102. The primary AGVs 106 are responsive to commands and instructions received from the CS 112. The primary AGVs 106 may include suitable logic, instructions, circuitry, interfaces, and/or codes, executable by the circuitry, for executing various operations, such as transporting payloads (e.g., the storage units or the racks 116) in the storage facility 102. For example, the primary AGVs 106 may carry and transport the storage units 216 from the storage area 104 to the operator station 110 and from the operator station 110 to the storage area 104 for fulfilment of orders, loading of inventory items into the storage units 216, and/or the like. The primary AGVs 106 may be configured to read the fiducial markers (e.g., the fiducial markers FM₁, FM₂, RM₁, and RM₂). For example, the primary AGVs 106 may include various sensors (such as image sensors, radio-frequency identification (RFID) sensors, and/or the like) for reading the fiducial markers. Each primary AGV 106 may utilize the fiducial markers for determining its relative position within the storage facility 102 and/or identifying the racks 116 or the storage units 216.

The auxiliary AGVs 108 are robotic vehicles that move in the storage facility 102. The auxiliary AGVs 108 may be responsive to the commands and instructions received from the CS 112. Each auxiliary AGV 108 may include suitable logic, instructions, circuitry, interfaces, and/or codes, executable by the circuitry, for executing a corresponding auxiliary operation. Examples of the auxiliary operation may include, but are not limited to, a navigation operation, a battery charging operation, a lifting operation, a path clearance operation, or the like. Each auxiliary AGV 108 may execute the corresponding auxiliary operation for providing a specific type of service to the primary AGVs 106, based on instructions received from the CS 112. For example, the first auxiliary AGV 108a may be configured to execute a battery charging operation to charge a battery of any of the primary AGVs 106. In another example, the second auxiliary AGV 108b may be configured to execute a navigation operation to provide a navigation service to any of the primary AGVs 106, for navigating the storage facility 102. In another example, the third auxiliary AGV 108c may be configured to execute a lifting operation to provide a lifting service to any of the primary AGVs 106, for lifting any storage unit or rack 116. In another example, the fourth auxiliary AGV 108d may be configured to execute a path clearance operation to provide a path clearance service to any of the primary AGVs 106, for clearing obstacles from a path of the primary AGVs 106. The auxiliary AGVs 108 may be configured to read the fiducial markers (e.g., the fiducial markers FM₁, FM₂, RM₁, and RM₂). For example, the auxiliary AGVs 108 may include various sensors (such as image sensors, RFID sensors, and/or the like) for reading the fiducial markers. Each auxiliary AGV 108 may utilize the fiducial markers for determining its relative position within the storage facility 102.

In some embodiments, the operator station 110 in the storage facility 102 is a pick-and-put station (PPS) where the inventory items may be placed in the storage units and/or retrieved from the storage units. The storage units 216 may be transported to the operator station 110 by the primary AGVs 106. The operator station 110 may include an operator device that receives various commands or instructions from the CS 112 for placing inventory items in the storage units or retrieving inventory items from the storage units. Based on the received commands or instructions, an operator at the operator station 110 may place the inventory items in the storage units 216 or retrieve the inventory items from the storage units 216. For the sake of illustration, in FIG. 1 the storage facility 102 is shown to include a single operator station (i.e., the operator station 110). However, it will be apparent to those of skill in the art that the storage facility 102 may include any number of operator stations without deviating from the scope of the present disclosure.

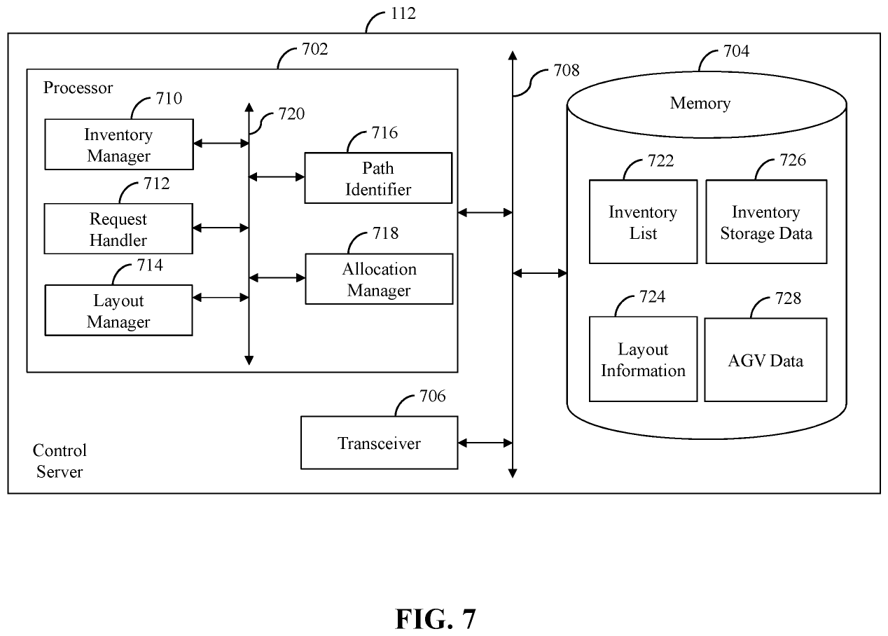

In some embodiments, the CS 112 is a network of computers, a software framework, or a combination thereof, that may provide a generalized approach to create the server implementation. Examples of the CS 112 include, but are not limited to, personal computers, laptops, mini-computers, mainframe computers, any non-transient and tangible machine that can execute a machine-readable code, cloud-based servers, distributed server networks, or a network of computer systems. The CS 112 may be realized through various web-based technologies such as, but not limited to, a Java web-framework, a .NET framework, a personal home page (PHP) framework, or any other web-application framework. The CS 112 may be maintained by a warehouse management authority or a third-party entity that facilitates inventory management operations for the storage facility 102. It will be understood by a person having ordinary skill in the art that the CS 112 may execute other warehouse management operations as well along with the inventory management operations. Various components of the CS 112 and their functionalities are described later in conjunction with FIG. 7.

In some embodiments, the CS 112 may store, in a memory of the CS 112, a virtual map and inventory storage data (as shown in FIG. 7) of the storage facility 102. The virtual map is indicative of locations of the racks 116, the storage units 216, the operator station 110, entry and exit points of the storage facility 102, the fiducial markers in the storage facility 102, or the like. The inventory storage data is indicative of associations between the inventory items stored in the storage facility 102 and the storage units 216 in the storage facility 102. The CS 112 receives various service requests from an external communication server for item retrieval from the storage facility 102 and item placement in the storage facility 102. Based on the received service requests, the CS 112 may identify one or more storage units 216 in the storage facility 102 that are associated with inventory items indicated by the received service requests.

After the identification of the storage units 216, the CS 112 may determine optimal paths in the storage facility 102 that need to be traversed for transporting the identified storage units 216 from the storage area 104 to the operator station 110. The CS 112 may further identify one or more primary AGVs from the primary AGVs 106 which are available for traversing the optimal paths to transport the identified storage units 216. After the identification of the available primary AGVs 106, the CS 112 may communicate instructions to the identified primary AGVs 106 to retrieve the identified storage units from the storage area 104. A command, communicated by the CS 112, to an identified primary AGV (e.g., the first primary AGV 106a) may include navigation information for the first primary AGV 106a to reach, from a current location of the first primary AGV 106a, a first location of an identified storage unit 216 and, then, a second location of the operator station 110 from the first location. In other words, the navigation information may define the optimal path to reach the operator station 110 from the current location after the identified storage unit 216 is picked by the first primary AGV 106a. The optimal path may be characterized by various fiducial markers that need be traversed by the first primary AGV 106a. In other words, the optimal path may be defined by a sequence of the fiducial markers that are to be traversed by the first primary AGV 106a to reach the operator station 110 from the current location after picking the identified storage unit 216. The navigation information may further include an identifier (e.g., a rack marker) of the identified storage unit that is to be transported by the first primary AGV 106a. The CS 112 may further receive information pertaining to real-time locations of the primary AGVs 106. For example, when the first primary AGV 106a is moving along the optimal path, the first primary AGV 106a notifies the CS 112 every time the first primary AGV 106a traverses a fiducial marker included in the optimal path. In other words, each primary AGV 106 may notify the CS 112 every time a fiducial marker in the storage facility 102 is crossed by the corresponding primary AGV 106.

In one exemplary scenario, an ongoing operation of a primary AGV (e.g., any of the primary AGVs 106) in the storage facility 102 may be hindered due to one or more factors. Examples of such factors may include an insufficient battery level of a battery of the corresponding primary AGV to complete the ongoing operation and a failure of a navigation unit of the corresponding primary AGV. Examples of such factors may further include presence of obstacles in a path (e.g., the optimal path) of the corresponding primary AGV, an inability of the corresponding primary AGV to lift a corresponding storage unit, or the like. In such an exemplary scenario, the primary AGV may require a specific type of service from one or more auxiliary AGVs of the auxiliary AGVs 108 for executing the ongoing operation without hindrance. Examples of the type of service required by the primary AGV may include the battery charging service, the navigation service, the path clearing service, the lifting service, or the like. Thus, the CS 112 may be configured to determine, for each primary AGV 106, a requirement for the type of service. In one embodiment, the CS 112 may determine, for each primary AGV 106, a real-time requirement for the type of service. In another embodiment, the CS 112 may determine, for each primary AGV 106, a future requirement for the type of service. In other words, the CS 112 may predict, for each primary AGV 106, the requirement for the type of service. For example, the CS 112 may determine that the first primary AGV 106a requires a first type of service for completing a corresponding ongoing operation, for example transportation of storage units 216 between various locations in the storage facility 102.

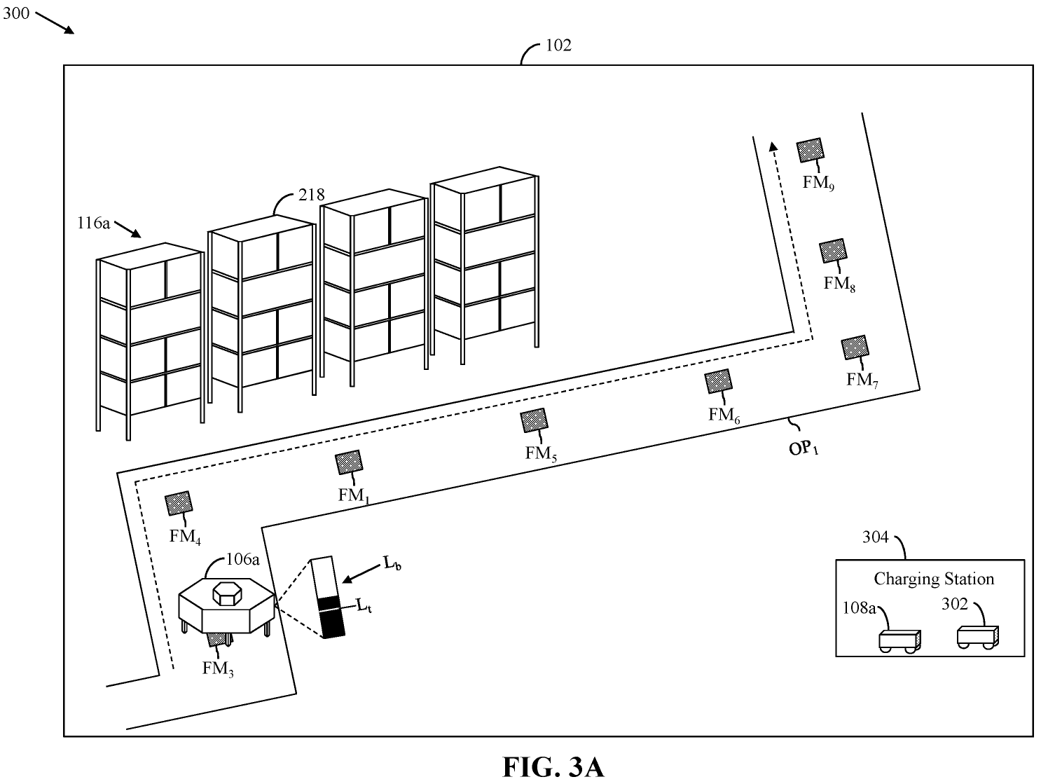

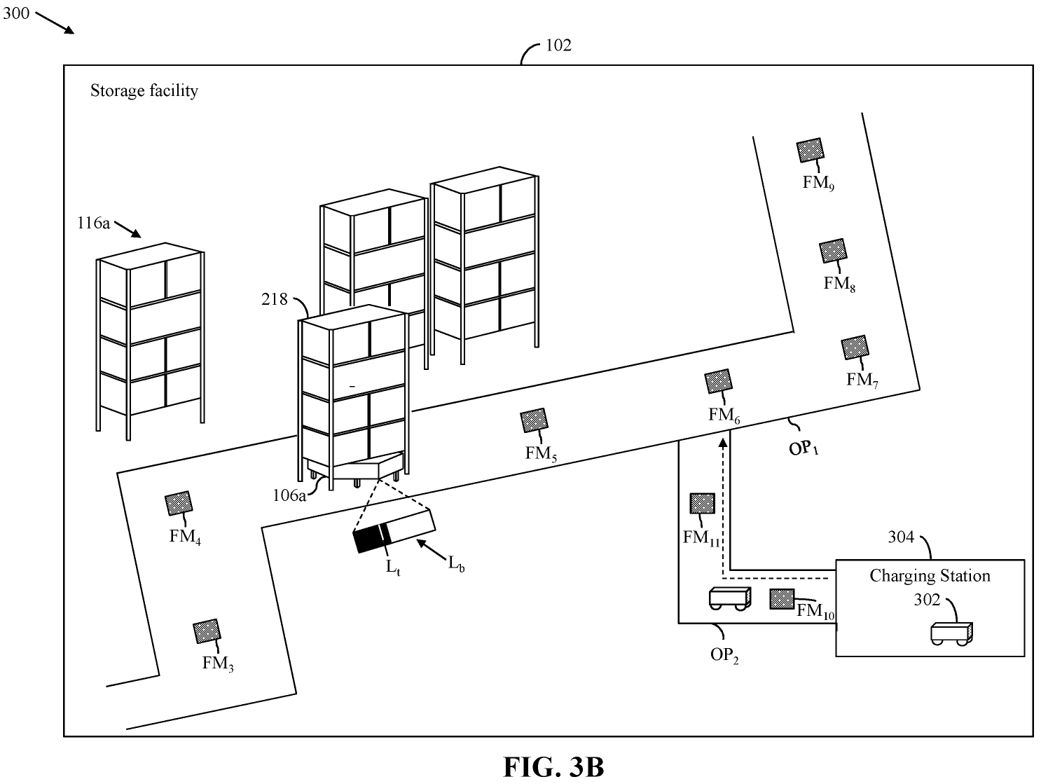

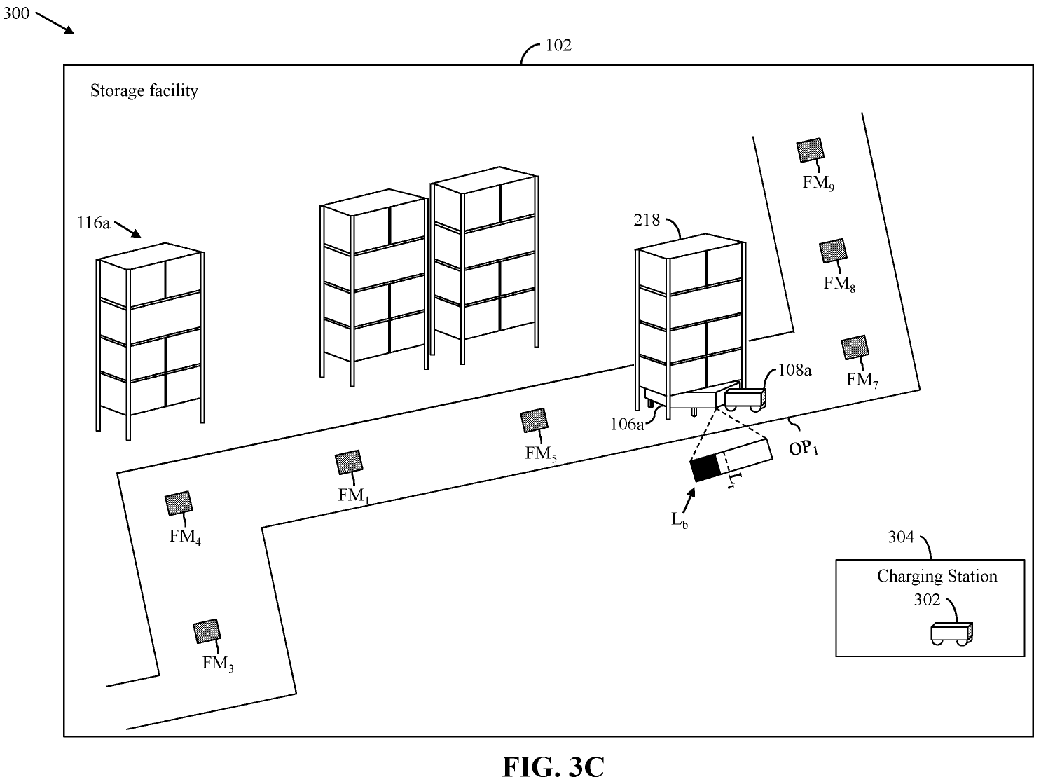

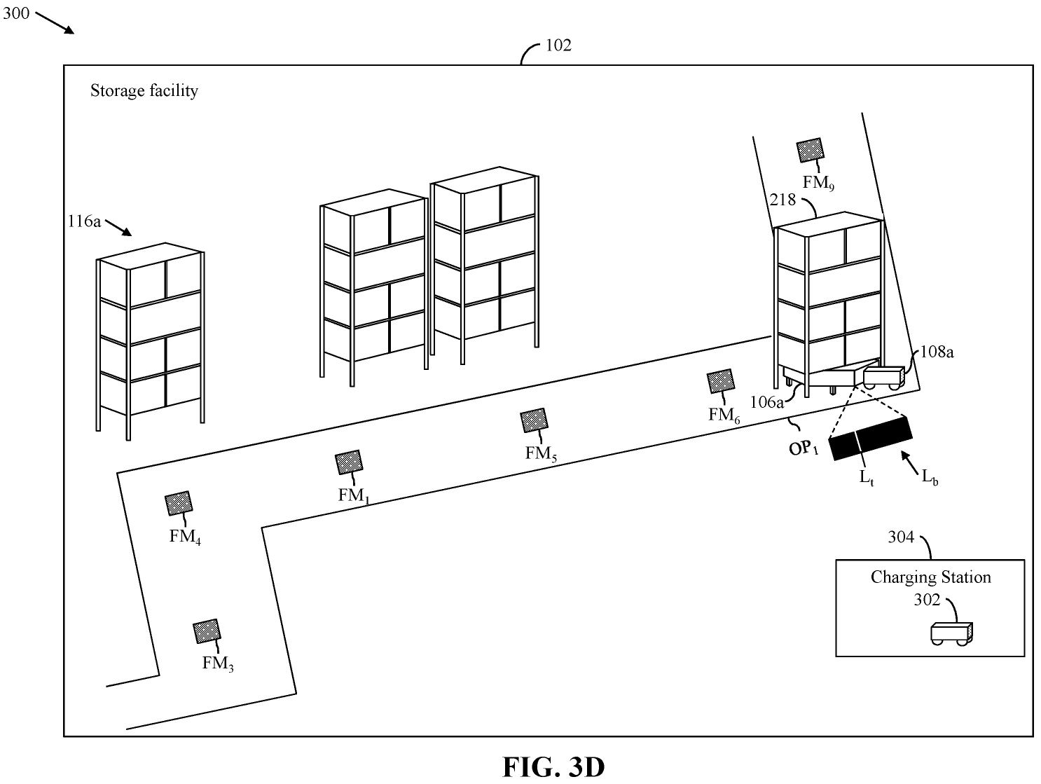

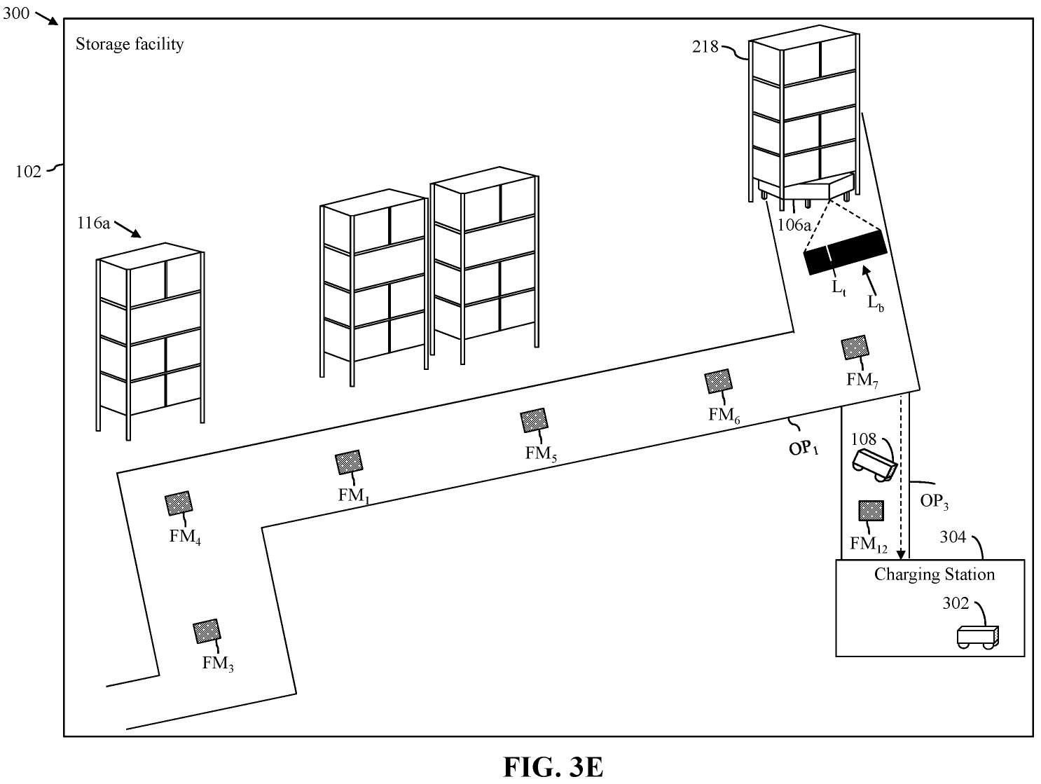

The CS 112 may then identify and select an auxiliary AGV from the auxiliary AGVs 108 that is capable of providing the first type of service to the first primary AGV 106a. The CS 112 may communicate a set of instructions to the identified auxiliary AGV for instructing the identified auxiliary AGV to provide the first type of service to the first primary AGV 106a. Based on the set of instructions, the identified auxiliary AGV reaches a location of the first primary AGV 106a and executes the corresponding auxiliary operation for providing the first type of service to the first primary AGV 106a. The first primary AGV 106a continues to execute the corresponding ongoing operation without hindrance, while the identified auxiliary AGV executes the corresponding auxiliary operation for providing the first type of service to the first primary AGV 106a. Likewise, the CS 112 may be configured to determine the requirements of the other primary AGVs 106b and 106c as well. Various operations performed by the auxiliary AGVs 108 and the CS 112 to cater to service requirement of the primary AGVs 106 are described in conjunction with FIGS. 3A-3E, 4A-4B, 5, and 6A-6C.

In some embodiments, the communication network 114 is a medium through which content and messages are transmitted between the primary AGVs 106, the auxiliary AGVs 108, the operator station 110, and the CS 112. Examples of the communication network 114 include, but are not limited to, a Wi-Fi network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and combinations thereof. Various entities in the environment 100 may connect to the communication network 114 in accordance with various wired and wireless communication protocols, such as Transmission Control Protocol and Internet Protocol (TCP/IP), User Datagram Protocol (UDP), Long Term Evolution (LTE) communication protocols, or any combination thereof.

FIG. 2A is a block diagram that illustrates the first primary AGV 106a, in accordance with one embodiment of the present disclosure. The first primary AGV 106a includes a first body 200, a first controller 202, a first moving mechanism 204 (such as first through third wheels 204a-204c, respectively), and a first lifting mechanism 206.

In some embodiments, the first controller 202 is provided to control functions of the first primary AGV 106a. The first controller 202 may receive commands and instructions from the CS 112 by way of a first transceiver included in the first body 200. The first body 200 may further include a first navigation unit 207, a first obstacle detection system (ODS) 208, a first fiducial marker reading system (FMRS) 210, a first weight measurement system (WMS) 212, a first engagement module (EM) 214, and a first battery 215.

In some embodiments, the first navigation unit 207 may include suitable logic, instructions, circuitry, interfaces, and/or codes, executable by the circuitry, for receiving navigation information from the CS 112. The navigation information may include path details of optimal paths that are to be traversed by the first primary AGV 106a. The first body 200 may further include a motor to control the first moving mechanism 204. The motor may be subject to control by the first controller 202 based on the navigation information. An example of the first navigation unit 207 may include a global positioning system (GPS). The first navigation unit 207 may further determine a real-time location of the first primary AGV 106a in the storage facility 102. The first controller 202 may utilize the first navigation unit 207 to navigate the storage facility 102.

In some embodiments, the first ODS 208 may include suitable logic, instructions, circuitry, interfaces, and/or codes, executable by the circuitry, for detecting obstacles in an optimal path traversed by the first primary AGV 106a. If the first ODS 208 detects an obstacle, the first controller 202 may decelerate the first primary AGV 106a to bring the first primary AGV 106a to a temporary halt until the obstacle is cleared, thereby avoiding a collision of the first primary AGV 106a with the obstacle.

In some embodiments, the first FMRS 210 may include suitable logic, instructions, circuitry, interfaces, and/or codes, executable by the circuitry, for scanning and reading the fiducial markers and, consequently, navigating the optimal path allocated to the first primary AGV 106a. The first FMRS 210 may communicate details of a fiducial marker to the first controller 202 when the first primary AGV 106a reaches the fiducial marker. Consequently, the first controller 202 may communicate the details of the fiducial marker to the CS 112 by way of the first transceiver. The CS 112 tracks the movement of the first primary AGV 106a by way of the details of the fiducial markers communicated by the first controller 202 to the CS 112.

In some embodiments, the first WMS 212 may include suitable logic, instructions, circuitry, interfaces, and/or codes, executable by the circuitry, for measuring a weight of a payload (e.g., the storage unit 216) carried by the first primary AGV 106a. Based on the weight of the payload, the first controller 202 controls the first lifting mechanism 206 for lifting the payload. The first lifting mechanism 206 may include a contact plate that may be raised or lowered based on the weight of the payload to lower a center of gravity of the first primary AGV 106a. A low center of gravity may be necessary to ensure that the payload is stable when carried by the first primary AGV 106a. The height by which a payload is raised above a floor level of the floor is dependent upon the weight of the payload, an evenness of the floor, or the like.

In some embodiments, the first EM 214 may include suitable logic, instructions, circuitry, interfaces, and/or codes, executable by the circuitry, for allowing the first primary AGV 106a to communicate and/or engage with the auxiliary AGVs 108. In a non-limiting example, the first EM 214 may include a first set of physical ports that allow the first primary AGV 106a to engage in physical contact with one or more auxiliary AGVs 108. In one embodiment, the first EM 214 may enable the first primary AGV 106a to engage with multiple auxiliary AGVs 108, simultaneously.

In some embodiments, the first battery 215 is a rechargeable battery used by the first primary AGV 106a to power operations (e.g., the first operation) executed by the first primary AGV 106a. The first battery 215 may be one of a lead-acid battery, a lithium-ion battery, a lead-acid battery, a nickel-metal hydride battery, or the like.

It will be apparent to those of skill in the art that the second and third primary AGVs 106b and 106c are functionally similar to the first primary AGV 106a. In some embodiments, the second and third primary AGVs 106b and 106c may be structurally different from the first primary AGV 106a. For example, a size, a shape, or dimensions of the second primary AGV 106b may be different from a size, a shape, or dimensions of the first primary AGV 106a.

FIG. 2B is a block diagram that illustrates the first primary AGV 106a carrying a first storage unit 216 of the first rack 116a, in accordance with one embodiment of the present disclosure. The first primary AGV 106a may reach a location of the first storage unit 216 and carry the first storage unit 216 based on instructions received from the CS 112. In a non-limiting example, the first storage unit 216 stores inventory items 218 and 220. As shown in FIG. 2B, the first storage unit 216 is lifted by way of the first lifting mechanism 206.

FIGS. 3A-3E are block diagrams that collectively illustrate an exemplary scenario 300 for providing a battery charging service to the first primary AGV 106a, in accordance with one non-limiting embodiment of the present disclosure. With reference to FIG. 3A, the exemplary scenario 300 involves the first primary AGV 106a, the first auxiliary AGV 108a, the CS 112, the communication network 114, the first storage unit 216, a fifth auxiliary AGV 302, a charging station 304, and the fiducial markers in the storage facility 102.

In the exemplary scenario, the CS 112 receives a first service request from the external communication server. The first service request may be an item placement request or an item retrieval request. In a non-limiting example, it is assumed that the first service request is an item placement request. The first service request may include information pertaining to a first item that is to be stored in the storage facility 102. The CS 112 allocates the first service request to the operator station 110 based on an availability of the operator station 110. The CS 112 then retrieves the virtual map of the storage facility 102 and the inventory storage data of the storage facility 102 from the memory of the CS 112. Based on the inventory storage data, the CS 112 identifies various storage units that are associated with the first item. In a non-limiting example, it is assumed that the CS 112 identifies the first storage unit 216 to be associated with the first item. Thus, the CS 112 determines that the first storage unit 216 is to be transported to the operator station 110 for the placement of the first item in the first storage unit 216.

In the exemplary scenario, the CS 112 then identifies a location of the first storage unit 216 by referring to the virtual map. In the exemplary scenario, the CS 112 identifies that the first storage unit 216 has the fiducial marker (i.e., the rack marker) RM₁ and that the first storage unit 216 partly constitutes the first rack 116a. The CS 112 further identifies that the first storage unit 216 is accessible from the first aisle 118a and is located adjacent to the fiducial marker FM₁ in the first aisle 118a (as shown in FIG. 1). The CS 112 further identifies the primary AGVs 106 that are available for transporting the first storage unit 216 to the operator station 110. The CS 112 may identify the available primary AGVs 106 based on various factors, such as a proximity of a primary AGV (e.g., the first primary AGV 106a) to the first storage unit 216, a required throughput for fulfilling the first service request, or the like. The CS 112 then selects a primary AGV from the available primary AGVs 106, such that a time taken to transport the first storage unit 216 to the operator station 110 by the selected primary AGV is minimum. In one exemplary scenario, the CS 112 may identify that the first through third primary AGVs 106a-106c are available and the CS 112 may select the first primary AGV 106a based on a proximity of the first primary AGV 106a to the first storage unit 216.

After the selection of the first primary AGV 106a, the CS 112 determines a first optimal path OP₁ that needs to be traversed by the first primary AGV 106a for transporting the first storage unit 216 to the operator station 110 (i.e., a first operation). The CS 112 may determine the first optimal path OP₁ based on a real-time location of the first primary AGV 106a, a location of the first storage unit 216, and/or a location of the operator station 110. In one exemplary scenario, the CS 112 may determine, at a first time-instance (i.e., at t=t₀) when the first service request is received, that the first primary AGV 106a is at a location that corresponds to a fiducial marker FM₃. The CS 112 further determines that the location of the first storage unit 216 corresponds to the fiducial marker FM₁ and that the location of the operator station 110 corresponds to the fiducial marker FM₉. In such a scenario, the first optimal path OP₁ determined by the CS 112 is characterized by sequential traversal of the fiducial markers FM₃, FM₄, FM₁, FM₅, FM₆, FM₇, FM₉, and FM₉ (i.e., FM₃→FM₄→FM₁→FM₅→FM₆→FM₇→FM₈→FM₉). The CS 112 then communicates a first set of instructions to the first primary AGV 106a, instructing the first primary AGV 106a to transport the first storage unit 216 to the operator station 110 (i.e., a first operation). In other words, the CS 112 allocates the first operation to the first primary AGV 106a. The first set of instructions may include path details of the first optimal path OP₁. Based on the first set of instructions, the first primary AGV 106a begins to execute the first operation, i.e., the first primary AGV 106a begins to traverse the first optimal path OP₁ for transporting the first storage unit 216 to the operator station 110.

In an exemplary scenario, the CS 112 further obtains operating parameters (e.g., a first velocity, a first load carrying capacity, or the like) of the first primary AGV 106a. In one embodiment, the CS 112 may retrieve the operating parameters of the first primary AGV 106a from the memory of the CS 112. In another embodiment, the CS 112 may communicate with the first primary AGV 106a for obtaining the operating parameters from the first primary AGV 106a. Based on the operating parameters of the first primary AGV 106a, the CS 112 predicts a location of the first primary AGV 106a at various time-instances. Based on the predicted locations, the CS 112 may generate a virtual graph that indicates a predicted trajectory of the first primary AGV 106a as a function of time. For example, the virtual graph may indicate that at the first time-instance (i.e., at t=t₀), a second time-instance (i.e., at t=t₁), and a third time-instance (i.e., at t=t₂) the first primary AGV 106a may be positioned at first, second, or third locations, respectively, in the storage facility 102. In a non-limiting example, it is assumed that the first location corresponds to the fiducial marker FM₃, the second location corresponds to the fiducial marker FM₁, and the third location corresponds to the fiducial marker FM₆. In other words, the CS 112 predicts that the first primary AGV 106a may be positioned at the fiducial marker FM₁ at the second time-instance (i.e., at t=t₁) and at the fiducial marker FM₆ at the third time-instance (i.e., at t=t₂). Based on historical data pertaining to battery discharge rates of the first battery 215, the CS 112 further predicts a battery level ‘L_{b}’ that the first battery 215 may have at each time-instance in the virtual graph. Thus, the virtual graph generated by the CS 112 may further indicate the predicted battery level L_{b} of the first battery 215 at each time-instance corresponding to the virtual graph. The CS 112 further determines a first threshold level ‘Lₜ’ for the first battery 215. The first threshold level Lₜ may refer to a minimum battery level of the first battery 215 that is to be maintained by the first primary AGV 106a at all times. The first threshold level Lₜ may be determined based on various factors such as, but not limited to, the first storage unit 216 the first velocity of the first primary AGV 106a, the historical data regarding battery discharge rates of the first battery 215, or the like.

Based on the first threshold level Lₜ and the virtual graph, the CS 112 may determine that at the first time-instance (i.e., at t=t₀) the battery level L_{b} of the first battery 215 is greater than the first threshold level Lₜ. The CS 112 may further determine that the battery level L_{b} of the first battery 215 may fall below the first threshold level Lₜ at the third time-instance (i.e., at t=t₂), i.e., when the first primary AGV 106a is predicted to be positioned at the fiducial marker FM₆. Thus, the CS 112 determines that the first battery 215 needs to be charged at the third time-instance (i.e., at t=t₂) in order to maintain the battery level L_{b} above the first threshold level Lₜ of the first battery 215. In other words, the CS 112 predicts that at the third time-instance (i.e., at t=t₂), the first primary AGV 106a requires the battery charging service.

Based on the determination of the requirement for the battery charging service, the CS 112 may identify a set of auxiliary AGVs (e.g., the first auxiliary AGV 108a and a fifth auxiliary AGV 302) that are capable of executing a battery charging operation (i.e., capable of executing a first auxiliary operation). The CS 112 may then select one of the first and fifth auxiliary AGVs 108a and 302 for executing the first auxiliary operation (i.e., charging the first battery 215 of the first primary AGV 106a). The selection of the auxiliary AGV for charging the first battery 215 may be based on a variety of factors such as, but are not limited to, availability of the first and fifth auxiliary AGVs 108a and 302 at the third time-instance (i.e., at t=t₂), battery levels of batteries of the first and fifth auxiliary AGVs 108a and 302, proximity of the first and fifth auxiliary AGVs 108a and 302 to the first primary AGV 106a, or the like. In the current embodiment, the first and fifth auxiliary AGVs 108a and 302 are docked at a charging station 304. The charging station 304 may be a portable or a fixed charging station that includes circuitry for charging the batteries of the first and fifth auxiliary AGVs 108a and 302. For the sake of illustration, in FIG. 3A a single charging station 304 is shown. It will be apparent to those of skill in the art that the storage facility 102 may include any number of charging stations that are optimally located at strategic locations throughout the storage facility 102 without deviating from the scope of the present disclosure.

In a non-limiting example, it is assumed that the CS 112 selects the first auxiliary AGV 108a for providing the battery charging service to the first primary AGV 106a. The CS 112 then determines a second optimal path OP₂ that is to be followed by the first auxiliary AGV 108a to reach the fiducial marker FM₆ for providing the battery charging service to the first primary AGV 106a at the third time-instance (i.e., at t=t₂). The CS 112 may determine the second optimal path OP₂ such that a distance to be travelled by the first auxiliary AGV 108a is minimized. In this embodiment, the second optimal path OP₂ determined by the CS 112 is characterized by sequential traversal of the fiducial markers FM₁₀, FM₁₁, and FM₆ (i.e., FM₁₀→FM₁₁→FM₆) as shown in FIG. 3B.

In some embodiments, the CS 112 may communicate a second set of instructions to the first auxiliary AGV 108a, instructing the first auxiliary AGV 108a to execute the battery charging operation to provide the battery charging service to the first primary AGV 106a. The second set of instructions may further include location information of the first primary AGV 106a, path details of the second optimal path OP₂, and details of a time-instance at which the first auxiliary AGV 108a is to begin traversing the second optimal path OP₂, or the like. In a non-limiting example, the CS 112 may instruct the first auxiliary AGV 108a to begin traversing the second optimal path OP₂ at the second time-instance (i.e., at t=t₁), thereby ensuring that the first auxiliary AGV 108a reaches the fiducial marker FM₆ by the third time-instance (i.e., at t=t₂). Therefore, at the first time-instance (i.e., at t=t₀), the first primary AGV 106a begins traversing the first optimal path OP₁, while the first auxiliary AGV 108a remains stationary at the charging station 304.

Referring now to FIG. 3B, the exemplary scenario 300 illustrates that the first primary AGV 106a has reached the first location at the second time-instance (i.e., at t=t₁), and is carrying the first storage unit 216. The battery level L_{b} of the first battery 215 at the second time-instance (i.e., at t=t₁) is lower than the battery level L_{b} of the first battery 215 at the first time-instance (i.e., at t=t₀) and is greater than the first threshold level Lₜ. At the second time-instance (i.e., at t=t₁), the first auxiliary AGV 108a has started traversing the second optimal path OP₂ based on the second set of instructions.

Referring now to FIG. 3C, the exemplary scenario 300 illustrates that at the third time-instance (i.e., at t=t₂) as predicted by the CS 112, the first primary AGV 106a has reached the third location (i.e., the fiducial marker FM₆) and is carrying the first storage unit 216. As predicted by the CS 112, the battery level L_{b} of the first battery 215 has fallen below the first threshold level Lₜ at the third time-instance (i.e., at t=t₂). When the first auxiliary AGV 108a reaches the third location, the first auxiliary AGV 108a begins to charge the first battery 215 of the first primary AGV 106a based on the second set of instructions from the CS 112. As shown in FIG. 3C, the first auxiliary AGV 108a engages in a physical contact with the first primary AGV 106a by way of the first EM 214 for charging the first battery 215. For example, the first auxiliary AGV 108a may include a second set of ports that mate with the first EM 214 of the first primary AGV 106a for executing the battery charging operation. For example, as shown in FIG. 3C, the first auxiliary AGV 108a has docked onto an external body of the first primary AGV 106a. In another embodiment, the first auxiliary AGV 108a may dock inside the first primary AGV 106a. In such a scenario, the first auxiliary AGV 108a may charge the first battery 215 and/or serve as a supplementary battery of the first primary AGV 106a for completing the first operation. In another embodiment, the first auxiliary AGV 108a may charge the first battery 215 by way of a wireless engagement between the first auxiliary AGV 108a and the first primary AGV 106a. Various other methods of charging the first battery 215 by the first auxiliary AGV 108a without deviating from the scope of the present disclosure will be apparent to the skilled artisan.

While the first auxiliary AGV 108a charges the first battery 215, the first primary AGV 106a may continue to traverse the first optimal path OP₁ without any hindrance to the execution of the first operation. The movements of the first auxiliary AGV 108a and the first primary AGV 106a are synchronized while the first auxiliary AGV 108a charges the first battery 215. For example, the first primary AGV 106a and the first auxiliary AGV 108a may traverse the first optimal path OP₁ at the same velocity until the first battery 215 is fully charged by the first auxiliary AGV 108a.

Referring now to FIG. 3D, the exemplary scenario 300 illustrates that at a fourth time-instance (i.e., at t=t₃), the first primary AGV 106a and the first auxiliary AGV 108a has reached a location corresponding to the fiducial marker FM₇. The first battery 215 is being charged by the first auxiliary AGV 108a, and it is assumed that at the fourth time-instance (i.e., at t=t₃), the battery level L_{b} of the first battery 215 reaches a full capacity. In other words, the first battery 215 is completely charged at the fourth time-instance (i.e., at t=t₃). Based on a monitoring of the battery level L_{b} of the first battery 215 by the CS 112, the CS 112, at the fourth time-instance (i.e., at t=t₃), determines that the first battery 215 is, now, fully charged. Consequently, the CS 112 may communicate a third set of instructions to the first auxiliary AGV 108a, instructing the first auxiliary AGV 108a to disengage from the first primary AGV 106a. The third set of instructions may also include path details of a third optimal path OP₃ (shown in FIG. 3E) from the location corresponding to the fiducial marker FM₇ and the charging station 304. The third optimal path OP₃ determined by the CS 112 is characterized by sequential traversal of the fiducial markers FM₇ and FM₁₂ (i.e., FM₇ FM₁₂) as shown in FIG. 3E. Based on the fourth set of instructions, the first auxiliary AGV 108a may stop executing the battery charging operation and disengage from the first primary AGV 106a.

Referring now to FIG. 3E, the exemplary scenario 300 illustrates that at a fifth time-instance (i.e., at t=t₄), the first primary AGV 106a has reached a location corresponding to the fiducial marker FM₉ and is carrying the first storage unit 216. In other words, the first primary AGV 106a continues executing the first operation without hindrance. The first battery 215 is shown to be fully charged. The first auxiliary AGV 108a is shown to be traversing the third optimal path OP₃ for reaching the charging station 304.

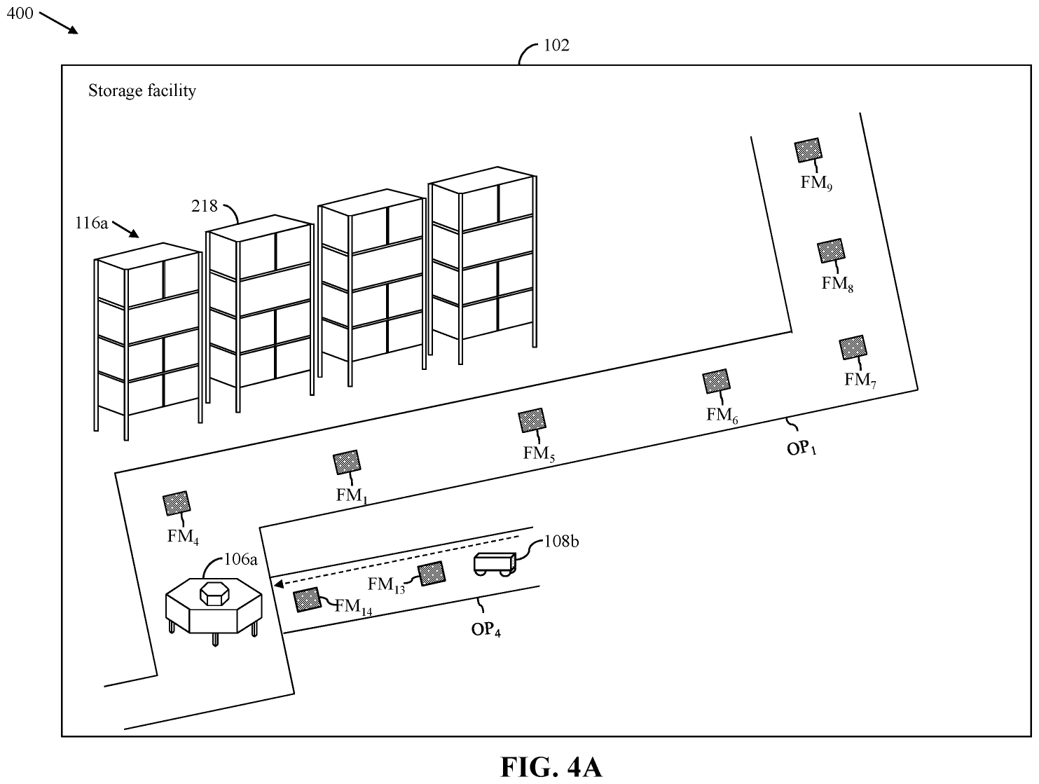

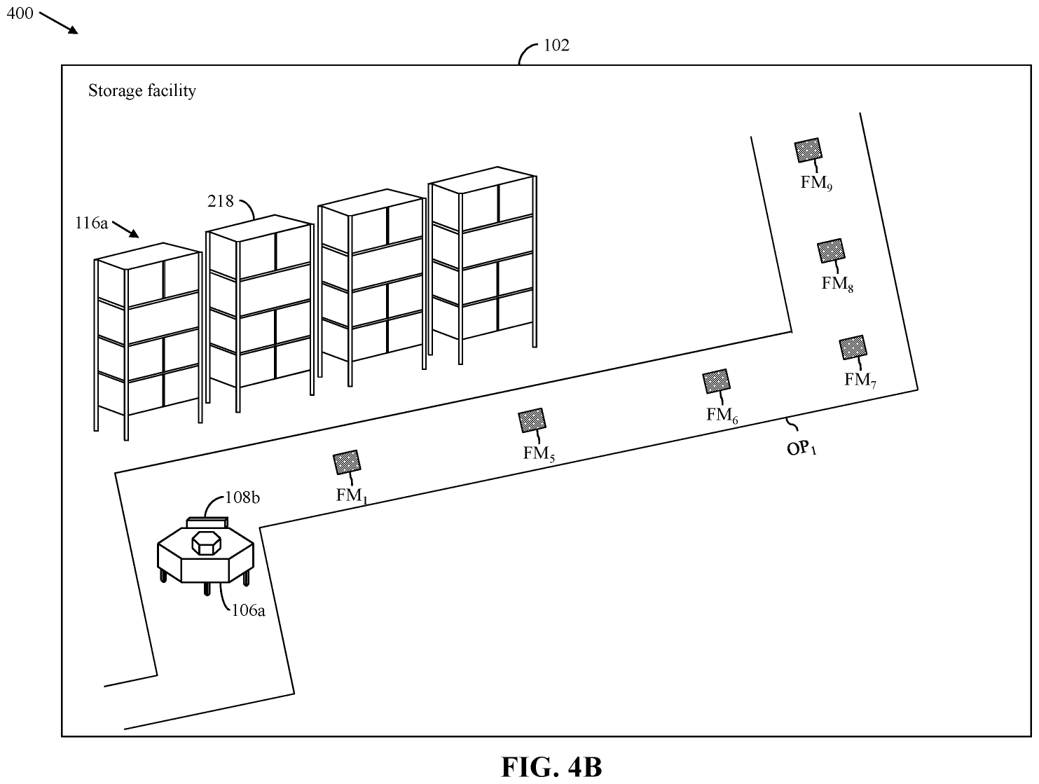

FIGS. 4A and 4B are block diagrams that collectively illustrate an exemplary scenario 400 for providing a navigation service to the first primary AGV 106a, in accordance with one embodiment of the present disclosure. With reference to FIG. 4A, the exemplary scenario 400 involves the first primary AGV 106a, the second auxiliary AGV 108b, the CS 112, the communication network 114, the rack 116, the first storage unit 216, and the fiducial markers in the storage facility 102. In a non-limiting example, it is assumed that the first primary AGV 106a is executing the first operation allocated by the CS 112.

At the first time-instance (i.e., at t=t₀), the first primary AGV 106a is positioned at the fiducial marker FM₃ (i.e., at the first location). The first primary AGV 106a may communicate a message to the CS 112, informing the CS 112 of a navigation failure. The message may imply a failure of the first FMRS 210 or the first navigation unit 207 of the first primary AGV 106a. Malfunctioning of the first FMRS 210 or the first navigation unit 207 may render the first primary AGV 106a incapable of navigating the first optimal path OP₁ for executing the first operation (i.e., transporting the first storage unit 216 to the operator station 110). Based on the received message, the CS 112 may determine a requirement of the first primary AGV 106a for the navigation service. Based on the determination of the requirement for the navigation service, the CS 112 may identify and select an auxiliary AGV (e.g., the second auxiliary AGV 108b) that is capable of executing the navigation operation for providing the navigation service. The selection of the second auxiliary AGV 108b may be based on a variety of factors such as, but not limited to, an availability of the second auxiliary AGV 108b at the first time-instance (i.e., at t=t₀), a battery level of a battery of the second auxiliary AGV 108b, proximity of the second auxiliary AGV 108b to the first primary AGV 106a, or the like. Based on the selection of the second auxiliary AGV 108b, the CS 112 may communicate a fourth set of instructions to the second auxiliary AGV 108b, instructing the second auxiliary AGV 108b to execute the navigation operation for providing the navigation service to the first primary AGV 106a. The fourth set of instructions may also include path details of a fourth optimal path OP₄ that is to be traversed by the second auxiliary AGV 108b to reach the first location for providing the navigation service to the first primary AGV 106a. In one exemplary scenario, the fourth optimal path OP₄ determined by the CS 112 is characterized by sequential traversal of the fiducial markers FM₁₃, FM₁₄, and FM₃ (i.e., FM₁₃→FM₁₄→FM₃). Based on the fourth set of instructions, the second auxiliary AGV 108b begins to traverse the fourth optimal path OP₄ at the first time-instance (i.e., at t=t₀) (as shown in FIG. 4A)_{.}

Referring now to FIG. 4B, the exemplary scenario 400 illustrates that the second auxiliary AGV 108b has reached the FM₃. When the second auxiliary AGV 108b reaches the fiducial marker FM₃, the CS 112 may communicate the path details of the first optimal path OP₁ to the second auxiliary AGV 108b. Based on the details of the first optimal path OP₁, the second auxiliary AGV 108b provides the navigation service to the first primary AGV 106a. For providing the navigation service, the second auxiliary AGV 108b may engage in physical contact with the first primary AGV 106a by way of the first EM 214 (as shown in FIG. 4B). After engaging, the second auxiliary AGV 108b executes the navigation operation, thereby guiding the first primary AGV 106a through the first optimal path OP₁. In another embodiment, where the second auxiliary AGV 108b does not engage in physical contact with the first primary AGV 106a, the first primary AGV 106a may follow the second auxiliary AGV 108b based on various techniques such as, but not limited to, infrared sensing, radio communication, line of sight communication, video processing, or the like, that do not involve the use of the first navigation unit 207. For example, the first primary AGV may detect a position of second auxiliary AGV and follow the movement of the second auxiliary AGV based on this detection. As part of the navigation operation, the second auxiliary AGV 108b may also guide the primary AGV 106a by communicating guidance instructions (such as, for example, “move forward”, “turn left”, “turn right”, etc.) to the primary AGV 106a so that the primary AGV 106a is able to traverse the first optimal path OP₁. In some embodiments, the guidance instructions may include, but are not limited to, providing specific movement instructions to the primary AGV 106a (e.g. “move forward”, “turn left”, “turn right”, etc.). In some embodiments, the guidance instructions include the information necessary for the primary AGV 106a to continue traversing the first optimal path OP₁. For non-limiting example, if the primary AGV 106a is unable to read the fiduciary markers, the second auxiliary AGV 108b may transmit fiduciary marker information to the primary AGV 106a. While the second auxiliary AGV 108b executes the navigation operation, the first primary AGV 106a continues to traverse the first optimal path OP₁ without any hindrance for executing the first operation.

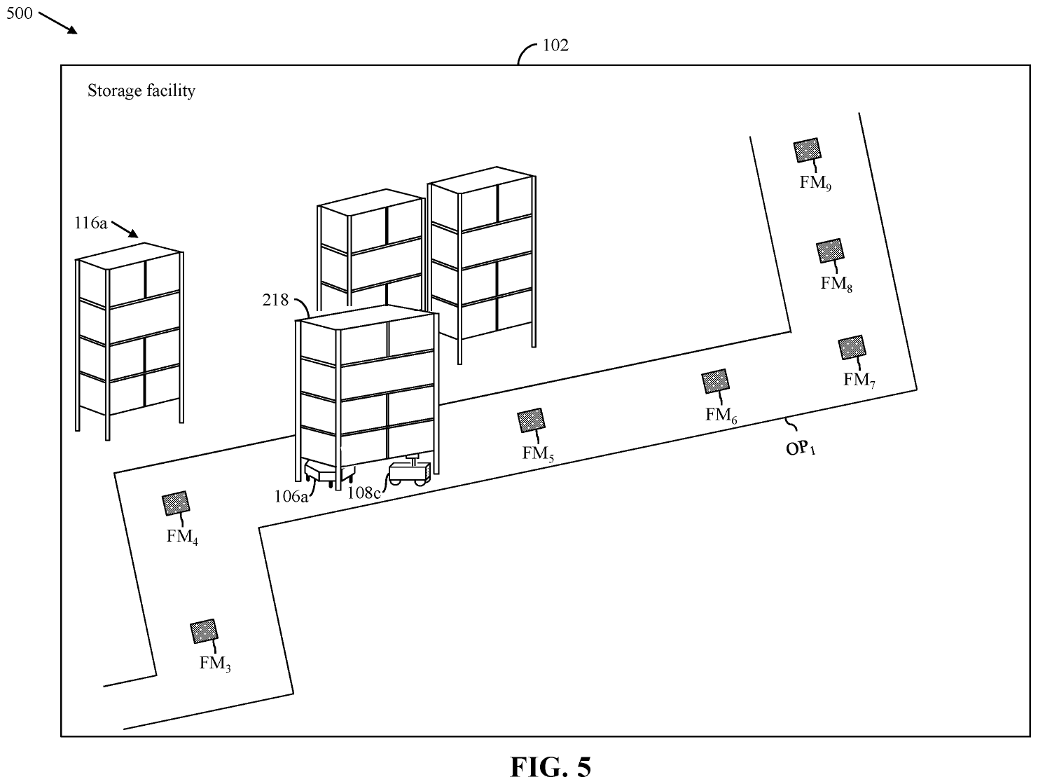

FIG. 5 is a block diagram that illustrates an exemplary scenario 500 for providing a lifting service to the first primary AGV 106a, in accordance with one embodiment of the present disclosure. The exemplary scenario 500 involves the first primary AGV 106a, the third auxiliary AGV 108c, the CS 112, the communication network 114, the rack 116, the first storage unit 216, and the fiducial markers in the storage facility 102. In a non-limiting example, it is assumed that the CS 112 allocates the first operation to the first primary AGV 106a.

The CS 112 may retrieve the inventory storage data from the memory of the CS 112 to determine characteristics (such as a shape, dimensions, and a weight) of the first storage unit 216. The CS 112 may further retrieve characteristics of the primary AGVs 106, stored in the memory of the CS 112, to identify a load carrying capacity of the first primary AGV 106a. Based on the load carrying capacity of the first primary AGV 106a and the characteristics of the first storage unit 216, the CS 112 may determine that the first primary AGV 106a requires the lifting service. For example, the load carrying capacity of the first primary AGV 106a may be less than the weight of the first storage unit 216. In such a scenario, the CS 112 may determine that the first primary AGV 106a requires the lifting service. The CS 112 may further predict a time-instance at which the CS 112 may require the lifting service. In this scenario where the first primary AGV 106a is allocated the task to transport the first storage unit 216, the CS 112 predicts that the first primary AGV 106a may require the lifting service at the second time-instance (i.e., at t=t₁) when the first primary AGV 106a may reach the fiducial marker FM₁ for picking the first storage unit 216. Thus, the CS 112 identifies and selects an auxiliary AGV (for example, the third auxiliary AGV 108c) capable of providing the lifting service to the first primary AGV 106a. The CS 112 may select the third auxiliary AGV 108c such that a sum of load carrying capacities of the first primary AGV 106a and the third auxiliary AGV 108c exceeds or equals the weight of the first storage unit 216. Based on the selection of the third auxiliary AGV 108c, the CS 112 communicates a fifth set of instructions to the third auxiliary AGV 108c for executing the lifting operation to provide the lifting service to the first primary AGV 106a. Based on the fifth set of instructions, the third auxiliary AGV 108c may reach the fiducial marker FM₁ (i.e., the second location) to provide the lifting service to the first primary AGV 106a. Thus, the third auxiliary AGV 108c and the first primary AGV 106a may collectively carry the first storage unit 216, and traverse the first optimal path OP₁ for transporting the first storage unit 216 to the operator station 110.

In another embodiment, the storage facility 102 may be a storage area in a manufacturing plant that has multiple assembly lines. In such a scenario, the first primary AGV 106a may be configured to execute a specific operation at an assembly line of the manufacturing plant. When the first primary AGV 106a requires an assistance in executing the assigned operation, the CS 112 may instruct an auxiliary AGV (for example, the third auxiliary AGV 108c) to provide an assistance service to the first primary AGV 106a. In one embodiment, based on the instructions. the third auxiliary AGV 108c may engage in physical contact with the first primary AGV 106a to provide the assistance service to execute the specific operation at the assembly line. In another embodiment, the third auxiliary AGV 108c may not engage in physical contact with the first primary AGV 106a for providing the assistance service.

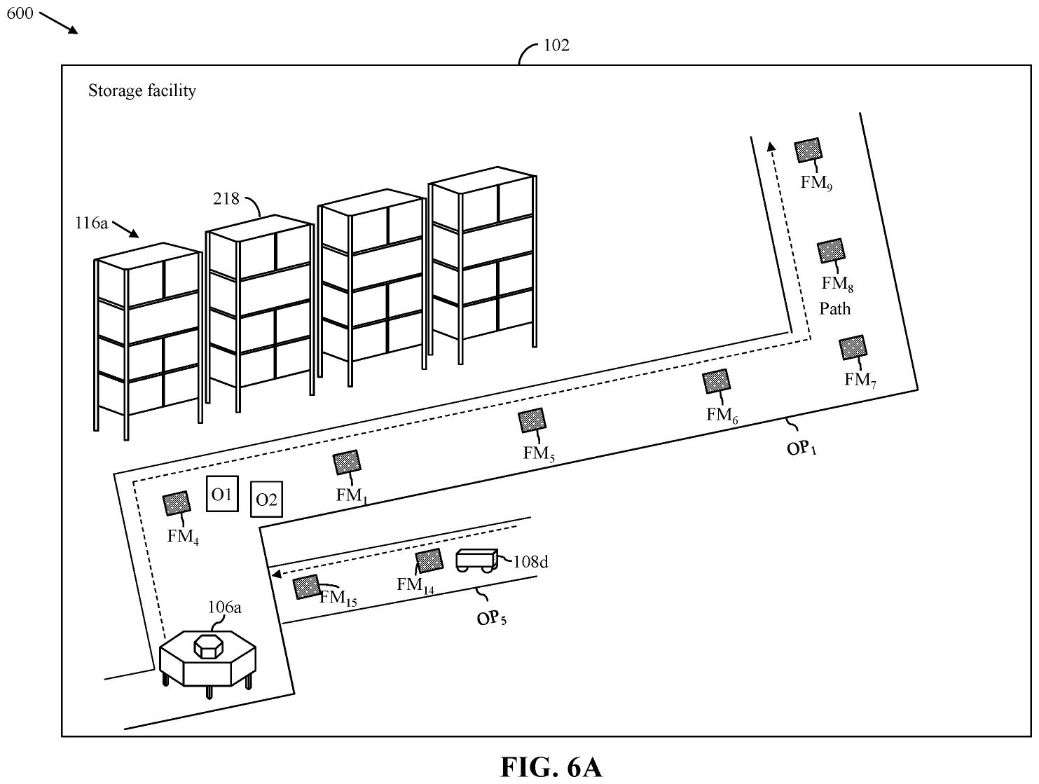

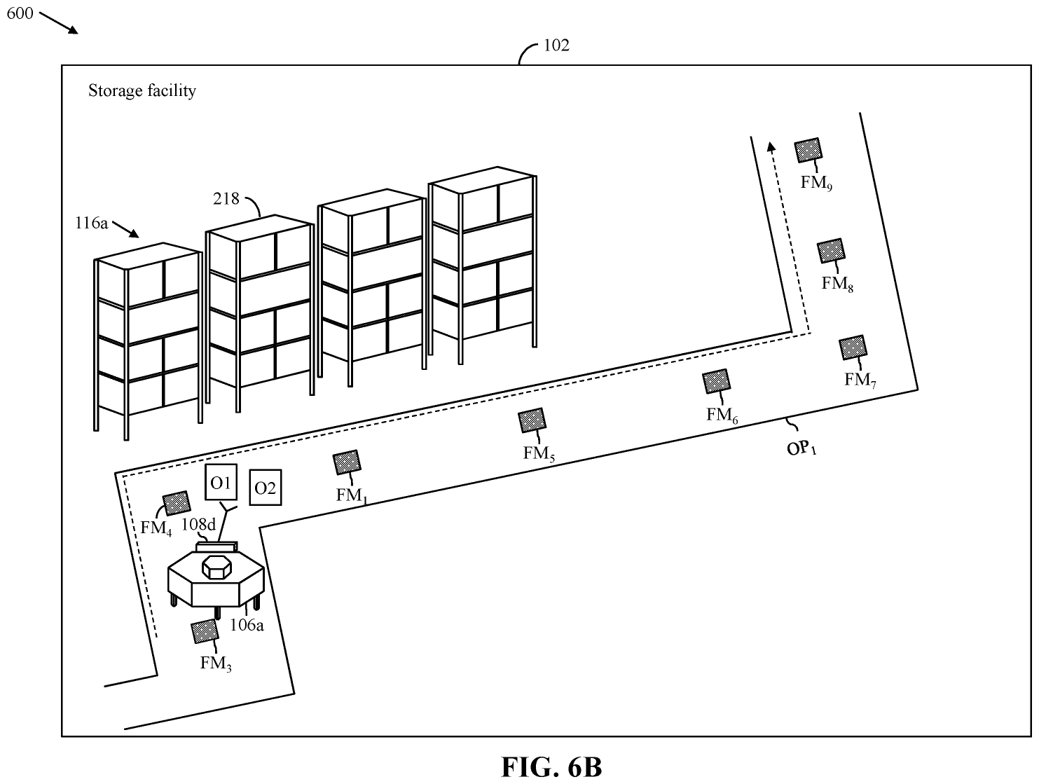

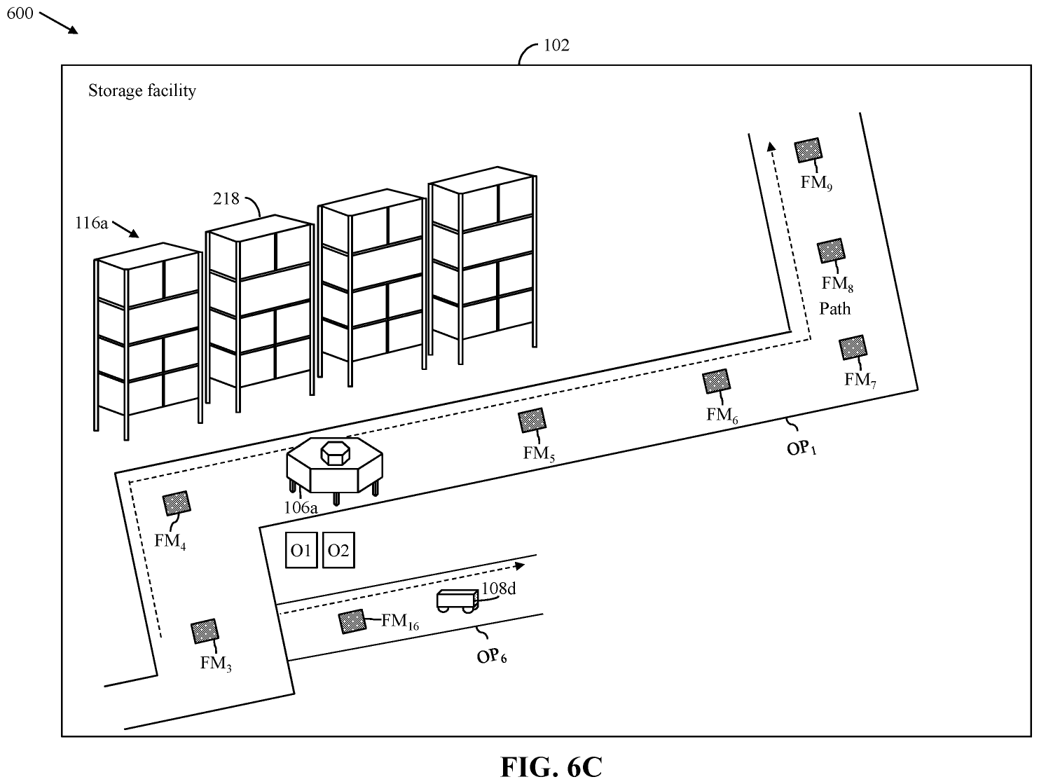

FIGS. 6A-6C are block diagrams that collectively illustrate an exemplary scenario 600 for providing a path clearance service for the first primary AGV 106a, in accordance with one embodiment of the present disclosure. With reference to FIG. 6A, the exemplary scenario 600 involves the first primary AGV 106a, the fourth auxiliary AGV 108d, the CS 112, the communication network 114, the rack 116, the first storage unit 216, the fiducial markers in the storage facility 102, and first and second obstacles O1 and O2. In a non-limiting example, it is assumed that the CS 112 has allocated the first operation of transporting the first storage unit 216 to the first primary AGV 106a. The first primary AGV 106a is required to traverse the first optimal path OP₁ for executing the first operation.

At the first time-instance (i.e., at t=t₀), the first primary AGV 106a is shown to be traversing the first optimal path OP₁ and is currently positioned at the location corresponding to the fiducial marker FM₃ (i.e., the first location). As shown in FIG. 6A, a portion of the first optimal path OP₁ between fiducial markers FM₄ and FM₁ may be blocked by the first and second obstacles O1 and O2. The first and second obstacles O1 and O2 may hinder the execution of the first operation by the first primary AGV 106a. The CS 112 may detect a presence of the first and second obstacles O1 and O2 on the first optimal path OP₁ based on various techniques such as, but not limited to, video processing of a live CCTV feed of the storage facility 102, a detection of the first and second obstacles O1 and O2 by the first ODS 208 of the first primary AGV 106a, or the like. Based on the detection of the first and second obstacles O1 and O2, the CS 112 may determine that there is a requirement of the first primary AGV 106a for the path clearance service (i.e., a type of service). In other words, the CS 112 determines that first and second obstacles O1 and O2 need to be cleared for the first primary AGV 106a to be able to traverse the first optimal path OP₁ for executing the first operation. Based on the determination of the requirement of the path clearance service, the CS 112 identifies and selects an auxiliary AGV (e.g., the fourth auxiliary AGV 108d) that is capable of providing the path clearance service to the first primary AGV 106a. Based on the selection of the fourth auxiliary AGV 108d, the CS 112 may communicate a sixth set of instructions to the fourth auxiliary AGV 108d, instructing the fourth auxiliary AGV 108d to execute the path clearance operation for providing the path clearance service to the first primary AGV 106a. The sixth set of instructions may include path details of a fifth optimal path OP₅ to be traversed by the fourth auxiliary AGV 108d and locations of the first and second obstacles O1 and O2. The fifth optimal path OP₅ may indicate an optimal path between a current location of the fourth auxiliary AGV 108d and the first location (i.e., the location of the first primary AGV 106a). In one exemplary scenario, the fifth optimal path OP₅ determined by the CS 112 is characterized by sequential traversal of fiducial markers FM₁₄, FM₁₅, and FM₃ (i.e., FM₁₄→FM₁₅→FM₃) as shown in FIG. 6B. Based on the sixth set of instructions, the fourth auxiliary AGV 108d begins to traverse the fifth optimal path OP₅ to reach the location corresponding to the fiducial marker FM₃.

Referring now to FIG. 6B, the exemplary scenario 600 illustrates that the fourth auxiliary AGV 108d has engaged in physical contact with the first primary AGV 106a for executing the path clearance operation. The fourth auxiliary AGV 108d and the first primary AGV 106a may move synchronously towards the first and second obstacles O1 and O2 (i.e., the first primary AGV 106a continues executing the first operation). When the fourth auxiliary AGV 108d and the first primary AGV 106a reach the location of the first and second obstacles O1 and O2, the fourth auxiliary AGV 108d executes the path clearance operation. In other words, the fourth auxiliary AGV 108d clears the first optimal path OP₁ by moving the first and second obstacles O1 and O2 out of the first optimal path OP₁. In one embodiment, the fourth auxiliary AGV 108d may deploy a protrusion or a robotic arm for executing the path clearance operation. After the first optimal path OP₁ is cleared, the fourth auxiliary AGV 108d may communicate a message to the CS 112, indicating that the first and second obstacles O1 and O2 have been cleared from the first optimal path OP₁.

In another embodiment, the fourth auxiliary AGV 108d may not need to engage in physical contact with the first primary AGV 106a for executing the path clearance operation. In another embodiment, the fourth auxiliary AGV 108d may carry the first and second obstacles O1 and O2 for clearing the first optimal path OP₁.

Referring now to FIG. 6C, the CS 112 communicates a seventh set of instructions to the fourth auxiliary AGV 108d when the path clearance operation is complete, instructing the fourth auxiliary AGV 108d to disengage from the first primary AGV 106a. The seventh set of instructions may further include path details of a sixth optimal path OP₆ determined by the CS 112. The sixth optimal path OP₆ is to be followed by the fourth auxiliary AGV 108d to reach another location (e.g., an auxiliary AGV station) from a current location of the fourth auxiliary AGV 108d. In one exemplary scenario, the sixth optimal path OP₆ determined by the CS 112 is characterized by sequential traversal of the fiducial markers FM₃ and FM₁₆ (i.e., FM₃→FM₁₆). The exemplary scenario 600 of FIG. 6C illustrates that the first and second obstacles O1 and O2 have been moved out of the first optimal path OP₁ and the first primary AGV 106a is executing the first operation by traversing the first optimal path OP₁ without any hindrance. Based on the seventh set of instructions, the fourth auxiliary AGV 108d disengages from the first primary AGV 106a and moves along the sixth optimal path OP₆ towards the auxiliary AGV station as shown in FIG. 6C. The first primary AGV 106a may continue performing the first operation.

FIG. 7 is a block diagram that illustrates the CS 112, in accordance with one embodiment of the present disclosure. In some embodiments, the CS 112 may include a processor 702, memory 704, and a transceiver 706 that communicate with each other by way of a first communication bus 708. The processor 702 may include an inventory manager 710, a request handler 712, a layout manager 714, a path identifier 716, and an allocation manager 718 that communicate with each other by way of a second communication bus 720. It will be apparent to a person having ordinary skill in the art that the CS 112 is for illustrative purposes and not limited to any specific combination or hardware circuitry and/or software.

In some embodiments, the processor 702 includes suitable logic, instructions, circuitry, interfaces, and/or codes for executing various operations, such as inventory or warehouse management operations, procurement operations, or the like. Examples of the processor 702 include, but are not limited to, an application-specific integrated circuit (ASIC) processor, a reduced instruction set computing (RISC) processor, a complex instruction set computing (CISC) processor, a field-programmable gate array (FPGA), and the like. The processor 702 executes the inventory management operations, such as identifying the optimal paths and determining service requirements of the primary AGVs 106 (as described in the foregoing descriptions of FIGS. 3A-3E, 4A-4B, 5, and 6A-6C), to facilitate retrieval inventory items from the storage units and placement of inventory items in the storage units.

In some embodiments, the memory 704 includes suitable logic, instructions, circuitry, interfaces, and/or codes to store an inventory list 722, layout information 724, the inventory storage data (hereinafter, referred to as ‘the inventory data 726’), and AGV data 728. Examples of the memory 704 include a random-access memory (RAM), a read-only memory (ROM), a removable storage drive, a hard disk drive (HDD), a flash memory, a solid-state memory, and the like. In one embodiment, the memory 704 may be realized through various database technologies such as, but not limited to, Microsoft® SQL, Oracle®, IBM DB2®, Microsoft Access®, PostgreSQL®, MySQL® and SQLite®. It will be apparent to a person skilled in the art that the scope of the present disclosure is not limited to realizing the memory 704 in the CS 112, as described herein. In other embodiments, the memory 704 may be realized in form of an external database server or a cloud storage working in conjunction with the CS 112, without departing from the scope of the present disclosure.

In some embodiments, the inventory list 722 includes a list of inventory items stored in the storage facility 102 and a number of units of each inventory item stored in the storage facility 102. The layout information 724 may include the virtual map of the storage facility 102. The virtual map may include information pertaining to the layout of the storage facility 102, such as the locations of the fiducial markers. The layout information 724 may further include an association between the fiducial markers and the racks 116 and the storage units (e.g., the first storage unit 216) that constitute the racks 116. The layout information 724 may indicate real time locations of the racks 116 and/or storage units based on the rack markers. The layout information 724 may further include real-time path availability information of various paths in the storage facility 102. For example, the layout information 724 may indicate that one or more paths (such as the aisles 118) are closed down for maintenance.

In some embodiments, the inventory storage data 726 may be indicative of the associations between the inventory items (e.g., the first item) and the storage units (e.g., the first storage unit 216). The inventory storage data 726 may include details of the inventory items stored in each storage unit of the racks 116. As described in the foregoing, each storage unit or each rack 116 may be associated with a rack marker. Based on the inventory storage data 726, the CS 112 is aware of the storage locations of the inventory items stored in the storage units and the racks 116. The AGV data 728 may be indicative of details of the primary AGVs 106 and the auxiliary AGVs (e.g., the first through fourth auxiliary AGVs 108a-108d and the fifth auxiliary AGV 302). The details of each of the first through third primary AGVs 106a-106c may include a size, dimensions, a load carrying capacity, a maximum and minimum speed, an identifier (such as a numeric or an alpha-numeric code) associated with the corresponding primary AGV, or the like. The details of each of the first through third primary AGVs 106a-106c may further include real-time information, such as a real-time location, an indicator that indicates whether the corresponding primary AGV is carrying a storage unit or a rack, a weight of the storage or the rack, or the like, of the corresponding primary AGV. It will be apparent to those of skill in the art that the details of the auxiliary AGVs 108 may be similar to the details of the primary AGVs 106. The details of each auxiliary AGV 108 may further include one or more types of services (e.g., the lifting service, the battery charging service, the path clearance service, the navigation service) that may be provided by the corresponding auxiliary AGV.

In some embodiments, the transceiver 706 transmits and receives data over the communication network 114 using one or more communication network protocols. The transceiver 706 may transmit various requests and messages to the primary AGVs 106, the auxiliary AGVs 108, and the operator station 110 and receives requests and messages from the primary AGVs 106, the auxiliary AGVs 108, and the operator station 110. Examples of the transceiver 706 include, but are not limited to, an antenna, a radio frequency transceiver, a wireless transceiver, a Bluetooth transceiver, an ethernet based transceiver, a universal serial bus (USB) transceiver, or any other device configured to transmit and receive data.

In some embodiments, the processor 702 executes the inventory or warehouse management operations by way of the inventory manager 710, the request handler 712, the layout manager 714, the path identifier 716, and the allocation manager 718. The inventory manager 710 may manage the inventory list 722 stored in the memory 704. For example, the inventory manager 710 may add new inventory items to the inventory list 722 when the new inventory items are stored in the storage area 104 and may update the inventory list 722 whenever there is any change in regards to the inventory items stored in the storage area 104 (e.g., when items are retrieved from storage unit for fulfilment of orders).

In some embodiments, the request handler 712 processes all service requests received from the external communication server. The request handler 712 may identify, based on the service requests (such as the first service request) received from the external communication server, inventory items pertinent to the service requests. The request handler 712 further identifies the storage units that store the inventory items associated with the service requests. The request handler 712 may further communicate, for fulfilment of the service requests, details regarding the inventory items to the operator station 110. In one embodiment, when the storage facility 102 does not have all inventory items specified in a service request, the request handler 712 may queue the service request for a specific time-interval until the storage facility 102 receives all the inventory items specified in the service request. In one embodiment, the request handler 712 merges various service requests (such as the first service request) to optimize fulfilment of the service requests.

In some embodiments, the layout manager 714 manages the layout information 724. For example, if there is any change in the layout of the storage facility 102 (such as a change in the arrangement of the racks 116 or the storage units), the layout manager 714 updates the layout information 724 based on the change in the layout. The path identifier 716 may be configured to determine the optimal paths (such as the first through third optimal paths OP₁-OP₃). The allocation manager 718 handles the allocation of the primary AGVs 106 to the storage units (e.g., the first storage unit 216) or the racks 116, based on the service requests (e.g., the first service request). For example, the allocation manager 718 may determine that the first primary AGV 106a is available to transport the first storage unit 216 and, thus, allocates the first primary AGV 106a to the first storage unit 216. Further, the allocation manager 718 may determine the requirements of the primary AGVs 106 for various types of services (e.g., the lifting service, the battery charging service, the path clearance service, the navigation service, or the like). The allocation manager 718 may further select the auxiliary AGVs 108 based on the determination of the requirements, and instruct each auxiliary AGV 108 to execute a corresponding auxiliary operation to provide the corresponding service to the corresponding primary AGV 106.

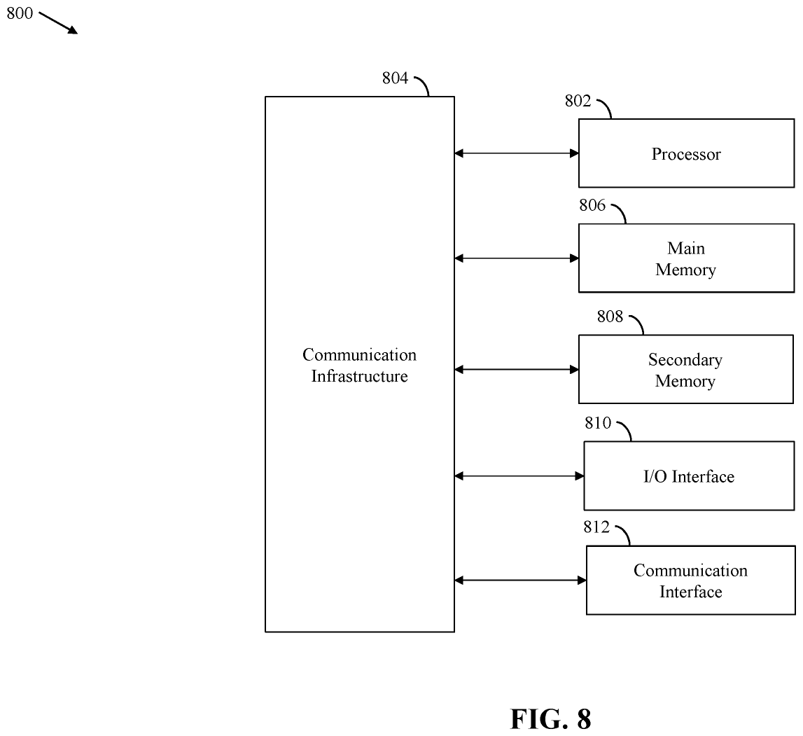

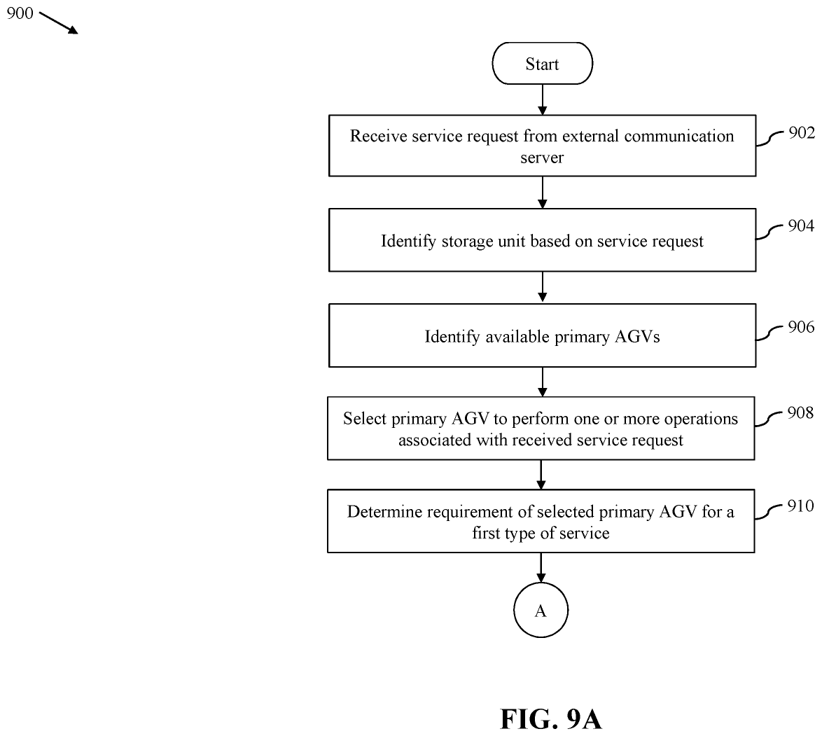

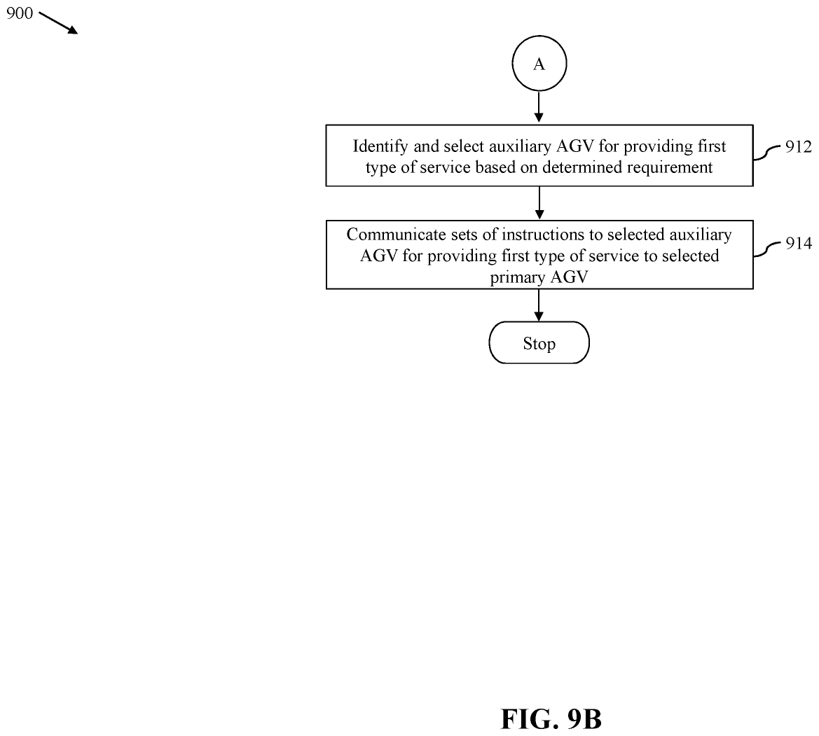

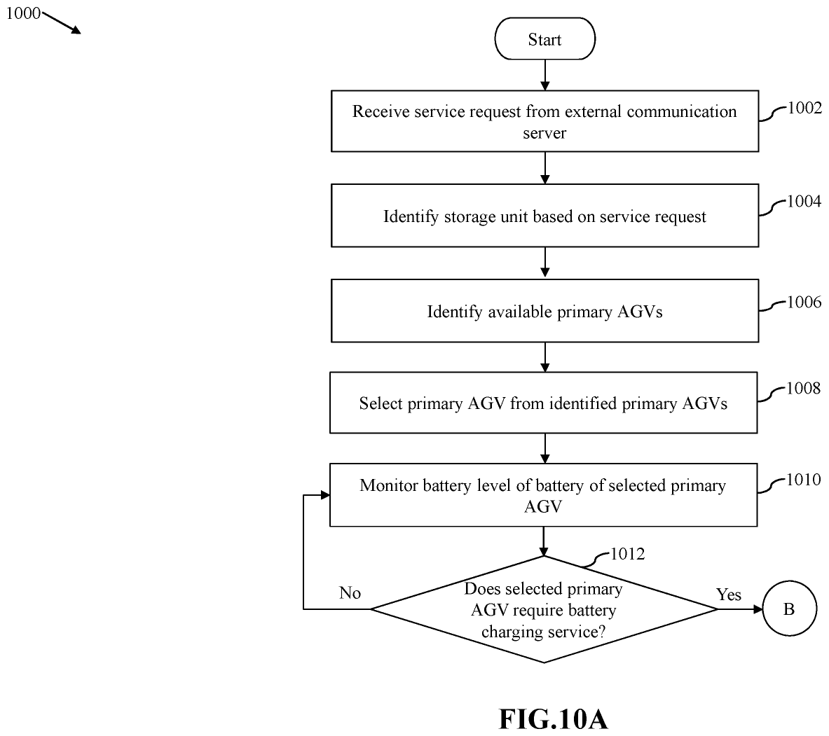

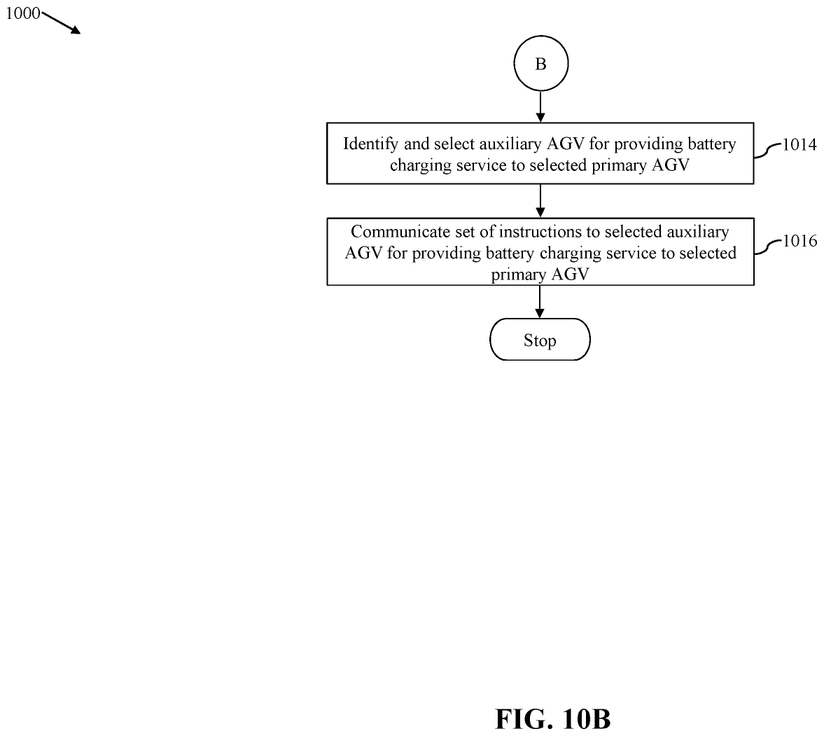

FIG. 8 is a block diagram that illustrates system architecture of a computer system 800, in accordance with one embodiment of the present disclosure. An embodiment of present disclosure, or portions thereof, may be implemented as computer readable code on the computer system 800. In one example, the primary AGVs 106 and the operator station 110 may be implemented in the computer system 800. Hardware, software, or any combination thereof may embody modules and components used to implement methods of FIGS. 9A and 9B and 10A and 10B. The computer system 800 may include a processor 802 that may be connected to a communication infrastructure 804. The computer system 800 may further include a main memory 806 and a secondary memory 808. The computer system 800 may further include an input/output (I/O) interface 810 and a communication interface 812. The communication interface 812 may allow data transfer between the computer system 800 and various devices that are communicatively coupled to the computer system 800.

FIGS. 9A and 9B, collectively represent a flow chart 900 that illustrates the method for facilitating one or more operations in the storage facility 102, in accordance with an embodiment of the present disclosure. FIGS. 9A and 9B are explained in conjunction with FIGS. 3A-3E, 4A and 4B, 5, and 6A-6C.

At step 902, the CS 112 receives a service request (e.g., the first service request) from the external communication server. At step 904, the CS 112 identifies one or more storage units (e.g., the first storage unit 216) based on the received service request (as described in the foregoing description of FIG. 3A). For example, the CS 112 identifies (e.g., the first item) inventory items pertaining to the received service request. Based on the inventory storage data 726, the CS 112 identifies storage units (e.g., the first storage unit 216) that are allocated to the inventory items associated with the received service request. At step 906, the CS 112 identifies primary AGVs (for example, the primary AGVs 106) that are available for performing operations (e.g., the first operation) associated with the received service request. At step 908, the CS 112 selects, from the identified primary AGVs 106, a primary AGV (e.g., the first primary AGV 106a) for performing the operation associated with the received service request. At step 910, the CS 112 determines a requirement of the selected primary AGV 106a for the first type of service (as described in the foregoing descriptions of FIGS. 3A-3E, 4A and 4B, 5, and 6A-6C). In one embodiment, the CS 112 may determine that the selected primary AGV requires more than one type of service. For example, the CS 112 may determine that the selected primary AGV requires the navigation and the battery charging services, simultaneously. At step 912, the CS 112 identifies and selects one or more auxiliary AGVs from the auxiliary AGVs 108 for providing the first type of service required by the selected primary AGV 106a. For example, the CS 112 may select the first auxiliary AGV 108a for providing the battery charging service to the selected primary AGV 106a. In another example, the CS 112 may select the first and second auxiliary AGVs 108a and 108b for providing the battery charging and the navigation services, simultaneously, to the selected primary AGV 106a. At step 914, the CS 112 may communicate sets of instructions to the selected auxiliary AGVs, instructing the selected auxiliary AGVs to execute corresponding auxiliary operations for providing corresponding auxiliary services to the selected primary AGV 106a. The selected auxiliary AGVs may execute the corresponding auxiliary operations for providing the corresponding auxiliary services to the selected primary AGV 106a, based on the sets of instructions.

FIGS. 10A and 10B, collectively represent a flow chart 1000 that illustrates the method for facilitating one or more operations in the storage facility 102, in accordance with another embodiment of the present disclosure. FIGS. 10A and 10B are explained in conjunction with FIGS. 3A-3E.

At step 1002, the CS 112 receives a service request (e.g., the first service request) from the external communication server. At step 1004, the CS 112 identifies one or more storage units (e.g., the first storage unit 216) based on the received service request (as described in the foregoing description of FIG. 3A). For example, the CS 112 identifies (e.g., the first item) inventory items pertaining to the received service request. Based on the inventory storage data 726, the CS 112 identifies storage units (e.g., the first storage unit 216) that are allocated to the inventory items associated with the received service request. At step 1006, the CS 112 identifies the primary AGVs 106 that are available for performing operations (e.g., the first operation) associated with the received service request. At step 1008, the CS 112 selects, from the identified primary AGVs 106, a primary AGV (e.g., the first primary AGV 106a) for performing the operations associated with the received service request. At step 1010, the CS 112 monitors the battery level L_{b} of the first battery 215 of the selected primary AGV 106a. At step 1012, the CS 112 determines whether the selected primary AGV 106a requires a battery charging service. The CS 112 may determine a requirement of the selected primary AGV for the battery charging service based on the virtual graph (as described in the foregoing description of FIGS. 3A-3E) and/or the monitored battery level L_{b}. If at step 1012, it is determined that the selected primary AGV 106a does not require the battery charging service, step 1010 is performed. If at step 1012, it is determined that the selected primary AGV 106a requires the battery charging service, step 1014 is performed. At step 1014, the CS 112 identifies and selects an auxiliary AGV from the auxiliary AGVs 108 for providing the battery charging service required by the selected primary AGV 106a. For example, the CS 112 may select the first auxiliary AGV 108a for providing the battery charging service to the selected primary AGV 106a. At step 1016, the CS 112 may communicate a set of instructions to the selected auxiliary AGV 108a, instructing the selected auxiliary AGV 108a to execute the battery charging operation for providing the battery charging service to the selected primary AGV 106a. The selected auxiliary AGV 108a may execute the battery charging operation for providing the battery charging service to the selected primary AGV 106a, based on the set of instructions.

In some embodiments, the CS 112 utilizes the auxiliary AGVs 108 to provide various types of services required by the primary AGVs 106 for seamless execution of operations (such as the first operation). Technological improvements in the primary AGVs 106 allow the primary AGVs 106 to continue executing operations even when the auxiliary AGVs 108 are rendering the various types of services required by the primary AGVs 106, thus, minimizing downtimes of the primary AGVs 106. For example, the first primary AGV 106a need not be taken out of service for charging the first battery 215 of the first primary AGV 106a. The first primary AGV 106a may be charged by the first auxiliary AGV 108a ‘on the fly’ while the first primary AGV 106a executes the first operation. Technological improvements in the CS 112 allow the CS 112 to predict service requirements (e.g., the battery charging service or the lifting service) of the primary AGVs 106 by monitoring real-time operating parameters of the primary AGVs 106. Consequently, a throughput of the storage facility 102 may be maximized. Based on technological improvements in the CS 112, the need of redundant primary AGVs or redundant hardware components in the primary AGVs 106 is overcome, resulting in significant monetary savings for organizations that may utilize the CS 112. For implementing the CS 112, no infrastructural upgrade is required to existing systems.

A person having ordinary skill in the art will appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however some of the operations may in fact be executed in parallel, concurrently, and/or in a distributed environment, and with program code stored locally or remotely for access by single or multiprocessor machines. In addition, in some embodiments the order of operations may be rearranged without departing from the spirit of the disclosed subject matter.

Techniques consistent with the present disclosure provide, among other features, systems and methods for synchronizing movement of primary AGVs in a storage facility. While various exemplary embodiments of the disclosed system and method have been described above it should be understood that they have been presented for purposes of example only, not limitations. It is not exhaustive and does not limit the embodiments of the present disclosure to the precise form disclosed. Modifications and variations are possible in light of the above teachings or may be acquired from practicing of the embodiments of the present disclosure, without departing from the breadth or scope.

While various embodiments of the present disclosure have been illustrated and described, it will be clear that the present disclosure is not limited to these embodiments only. Numerous modifications, changes, variations, substitutions, and equivalents will be apparent to those skilled in the art, without departing from the spirit and scope of the present disclosure, as described in the claims.

What is claimed is:

1. A system for facilitating one or more operations in a storage facility, the system comprising:
a primary automated guided vehicle (AGV) that is configured to execute a first operation of the one or more operations;
one or more auxiliary AGVs, wherein each auxiliary AGV is configured to execute an auxiliary operation; and
a server in communication with the primary AGV and the one or more auxiliary AGVs, the server being configured to:
determine a requirement of the primary AGV for a first type of service,
select a first auxiliary AGV from the one or more auxiliary AGVs based on the determination of the requirement for the first type of service, and
communicate a first set of instructions to the first auxiliary AGV, wherein, based on the first set of instructions, the first auxiliary AGV executes a corresponding auxiliary operation to provide the first type of service to the primary AGV.

2. The system of claim 1, wherein the first type of service is a battery charging service and the auxiliary operation executed by the first auxiliary AGV is a battery charging operation, and wherein, based on the first set of instructions, the first auxiliary AGV executes the battery charging operation to charge a battery of the primary AGV.

3. The system of claim 1, wherein the first type of service is a lifting service and the auxiliary operation executed by the first auxiliary AGV is a lifting operation, and wherein, based on the first set of instructions, the first auxiliary AGV executes the lifting operation to enable the primary AGV to lift a storage unit in the storage facility.

4. The system of claim 1, wherein the first type of service is a navigation service and the auxiliary operation executed by the first auxiliary AGV is a navigation operation, and wherein, based on the first set of instructions, the first auxiliary AGV executes the navigation operation to enable the primary AGV to navigate a path in the storage facility for executing the first operation.

5. The system of claim 1, wherein the first type of service is a path clearance service and the auxiliary operation executed by the first auxiliary AGV is a path clearance operation, and wherein, based on the first set of instructions, the first auxiliary AGV executes the path clearance operation for clearing one or more obstacles from a path that is to be traversed by the primary AGV for executing the first operation.

6. The system of claim 1, wherein the server is further configured to predict a time-instance at which the first type of service is required by the primary AGV, and wherein the requirement for the first type of service is determined based on the predicted time-instance.

7. The system of claim 1, wherein the server is further configured to:
determine a requirement of the primary AGV for a second type of service,
select a second auxiliary AGV from the one or more auxiliary AGVs, based on the determination of the requirement for the second type of service, and
communicate a second set of instructions to the second auxiliary AGV, wherein, based on the second set of instructions, the second auxiliary AGV executes a corresponding auxiliary operation to provide the second type of service to the primary AGV, while the primary AGV executes the first operation.

8. The system of claim 7, wherein the first and second auxiliary AGVs simultaneously provide the first and second type of services to the primary AGV, respectively, while the primary AGV executes the first operation.

9. A method for facilitating one or more operations in a storage facility, the method comprising:
determining, by a server, a requirement of a primary automated guided vehicle (AGV) for a first type of service, wherein the primary AGV is configured to execute a first operation of the one or more operations;
selecting, by the server, a first auxiliary AGV from one or more auxiliary AGVs based on the determination of the requirement for the first type of service, wherein each auxiliary AGV is configured to execute an auxiliary operation; and
communicating, by the server, a first set of instructions to the first auxiliary AGV, wherein, based on the first set of instructions, the first auxiliary AGV executes a corresponding auxiliary operation to provide the first type of service to the primary AGV.

10. The method of claim 9, wherein the first type of service is a battery charging service and the auxiliary operation executed by the first auxiliary AGV is a battery charging operation, and wherein, based on the first set of instructions, the first auxiliary AGV executes the battery charging operation to charge a battery of the primary AGV.

11. The method of claim 9, wherein the first type of service is a lifting service and the auxiliary operation executed by the first auxiliary AGV is a lifting operation, and wherein, based on the first set of instructions, the first auxiliary AGV executes the lifting operation to enable the primary AGV to lift a storage unit in the storage facility.

12. The method of claim 9, wherein the first type of service is a navigation service and the auxiliary operation executed by the first auxiliary AGV is a navigation operation, and wherein, based on the first set of instructions, the first auxiliary AGV executes the navigation operation to enable the primary AGV to navigate a path in the storage facility for executing the first operation.

13. The method of claim 9, wherein the first type of service is a path clearance service and the auxiliary operation executed by the first auxiliary AGV is a path clearance operation, and wherein, based on the first set of instructions, the first auxiliary AGV executes the path clearance operation for clearing one or more obstacles from a path that is to be traversed by the primary AGV for executing the first operation.

14. The method of claim 9, wherein the first auxiliary AGV engages in physical contact with the primary AGV for executing the corresponding auxiliary operation.

15. The method of claim 9, further comprising:
determining, by the server, a second type of service required by the primary AGV for executing the first operation;
selecting, by the server, a second auxiliary AGV from the one or more auxiliary AGVs based on the determined second type of service; and
communicating, by the server, a second set of instructions to the second auxiliary AGV, wherein, based on the second set of instructions, the second auxiliary AGV executes a corresponding auxiliary operation to provide the second type of service to the primary AGV, while the primary AGV executes the first operation.

16. The method of claim 15, wherein the first and second auxiliary AGVs simultaneously provide the first and second type of services to the primary AGV, respectively, while the primary AGV executes the first operation.

17. A primary automated guided vehicle (AGV), comprising:
a movement mechanism for traversing a path in a storage facility to execute a first operation; and
an engagement mechanism for allowing one or more auxiliary AGVs to engage with the primary AGV, wherein, when the primary AGV requires a first type of service, an auxiliary AGV of the one or more auxiliary AGVs engages with the primary AGV by way of the engagement mechanism and provides the first type of service to the primary AGV.

18. The primary AGV of claim 17, further comprising a battery for powering the primary AGV to execute the first operation.

19. The primary AGV of claim 17, further comprising a lifting mechanism for lifting a storage unit in the storage facility.

20. The primary AGV of claim 17, further comprising a controller for communicating with a server, wherein the primary AGV executes the first operation based on a set of instructions received from the server by way of the controller.
